(19) United States
(12) Patent Application Publication
(10) Pub. No.: US 2025/0111241 A1
(43) Pub. Date: Apr. 3, 2025

(54) METHOD AND SYSTEM FOR TRAINING A NEURAL NETWORK FOR COMBINATORIAL OPTIMIZATION

(71) Applicant: NAVER CORPORATION, Seongnam-si (KR)

(72) Inventors: Darko DRAKULIC, Grenoble (FR); Sofia MICHEL, Meylan (FR); Jan Florian MAI, Bruxelles (BE); Arnaud SORS, Grenoble (FR); Jean-Marc ANDREOLI, Meylan (FR)

(21) Appl. No.: 18/813,729

(22) Filed: Aug. 23, 2024

Related U.S. Application Data
(60) Provisional application No. 63/586,007, filed on Sep. 28, 2023.

(51) Int. Cl. G06N 3/092

(52) U.S. Cl. CPC G06N 3/092

(57) ABSTRACT

Methods and systems for training a neural network to solve a combinatorial optimization problem (COP). A solution space is received for the COP. The COP is modeled as a Markov Decision Process (MDP) over the solution space using a neural policy model for generating a sequence of actions. Training includes inputting a COP instance to the neural policy model as an initial state, receiving a determined action, updating the COP instance, including an objective and a set of feasible solutions, and inputting the updated COP instance to the neural policy model as a new state.

### REFERENCE TO RELATED APPLICATIONS

This application claims the benefit of and priority to U.S. Provisional Patent Application Ser. No. 63/586,007, filed Sep. 28, 2023, which application is incorporated in its entirety by reference herein.

### FIELD

The present disclosure relates generally to machine learning, and more particularly to methods and systems for training neural models for solving combinatorial optimization problems (COPs).

### BACKGROUND

Combinatorial Optimization (CO) problems are crucial in many application domains such as but not limited to transportation, energy, logistics, and others. Example problems include but are not limited to routing, scheduling, and bin packing. Because CO problems are generally NP-hard, their resolution at real-life scales is typically done by heuristics, which are efficient algorithms that generally produce good quality solutions. However, strong heuristics are generally problem-specific and designed by domain experts, and thus are heavily reliant on expert knowledge.

Neural combinatorial optimization (NCO) is an area of research that focuses on using deep neural networks to learn heuristics from data, possibly exploring regularities in problem instances of interest. Among NCO methods, so-called constructive approaches view the process of building a solution incrementally as a sequential decision making problem, which can be modeled with Markov Decision Processes (MDPs).

When MDPs have been used, the process of formulating an appropriate MDP, especially the state and action spaces, has usually been specific to each problem. Despite significant progress, out-of-distribution generalization, especially to larger instances, remains a significant hurdle.

### SUMMARY

Provided herein, among other things, are methods and systems for training a neural network to solve a combinatorial optimization problem (COP), the method comprising:
receiving a solution space for the COP that is a set of partial solutions for the COP, each partial solution including a sequence of one or more steps, wherein the COP has a set of COP instances, each of the set of COP instances including an objective and a finite, non-empty set of feasible solutions;
modeling the COP as a Markov Decision Process (MDP) over the solution space using a neural policy model for generating a sequence of actions over a plurality of time steps from an initial time step to a final time step according to a policy to provide an outcome, the neural policy model including a set of trainable policy parameters, wherein each generated action is either a step taken from a finite set of steps or a neutral action;
and
training the neural policy model, wherein said training comprises, for each of one or more initial COP instances:
at each of the plurality of time steps:
a) inputting to the neural policy model an input COP instance from the set of COP instances, the input COP instance being the initial COP instance at the initial time step or an updated COP instance from a previous time step at a remainder of the time steps, wherein each instance in the set of COP instances is an instance of the COP;
b) receiving a determined action based on the policy from the neural policy model;
c) if the determined action is the neutral action, maintaining the input COP instance;
d) if the determined action is a step, updating the input COP instance based on the step to provide the updated COP instance for a next time step, wherein said updating the input COP instance updates the set of feasible solutions and the objective, wherein the updated COP instance defines a tail subproblem of the input COP instance; and
e) if the determined action is a step, repeating steps a)-e) for the next time step;
and
updating the policy parameters to optimize the policy.

According to a complementary aspect, the present disclosure provides a computer program product, comprising code instructions to execute a method according to the previously described aspects; and a computer-readable medium, on which is stored a computer program product comprising code instructions for executing a method according to the previously described embodiments and aspects. The present disclosure further provides a processor configured using code instructions for executing a method according to the previously described embodiments and aspects.

Other features and advantages of the disclosed systems and methods will be apparent from the following specification taken in conjunction with the following drawings.

### DESCRIPTION OF THE DRAWINGS

The accompanying drawings are incorporated into the specification for the purpose of explaining the principles of the embodiments. The drawings are not to be construed as limiting the disclosure to only the illustrated and described embodiments or to how they can be made and used. Further features and advantages will become apparent from the following and, more particularly, from the description of the embodiments as illustrated in the accompanying drawings, wherein:

FIG. 1 shows an example method for training a neural network to solve a Combinatorial Optimization Problem (COP).

FIG. 2 shows a policy architecture for implementing a direct MDP.

FIG. 3 shows a policy architecture for implementing a reduced MDP.

FIG. 4 shows an example method for information flow in a reduced MDP.

FIG. 5 shows an example application for a direct MDP mapped to a reduced MDP for a CVRP (Capacitated Vehicle Routing Problem).

FIG. 6 illustrates an example of the KP (Knapsack Problem) direct MDP state mapped to a reduced KP (KP BQ-MDP) state.

FIG. 7 shows an example neural architecture providing a policy model for an example MDP method, configured for reduced MDP for Path-TSP (Traveling Salesman Problem).

FIG. 8 shows an example method for training a neural policy model.

FIG. 9 shows an example inference (runtime) method for solving a COP using a trained neural policy model.

FIGS. 10A and 10B show example plots for TSPLib solutions for two respective instances, including an optimal solution, a solution generated by a model according to an example embodiment (BS16), and solutions generated by MDAM and POMO.

FIGS. 11A and 11B show example plots for CVRPLib solutions for two respective instances, including an optimal solution, a solution generated by a model according to an example embodiment (BS16), and solutions generated by MDAM and POMO.

FIG. 12 shows an example construction for a MATAP (Multi Agent Task Assignment Problem) plan, including a plan as a sequence of steps (left) and the chronological view of the plan in a MATAP instance.

FIG. 13 shows example network architectures and environments.

In the drawings, reference numbers may be reused to identify similar and/or identical elements.

### DETAILED DESCRIPTION

### Introduction

Example systems and methods herein provide constructive neural combinatorial optimization NCO methods and associated networks, which build a solution to a COP incrementally by applying a sequence of elementary steps. The scope of such NCO methods may be large, as most COPs can be represented in this way. However, the representation of particular NCOs is not unique as the nature of the steps may be, to a large extent, a matter of choice.

Generally, given a choice of step space, solving such COPs can be performed by computing an optimal policy for sequentially selecting the steps in the construction of the combination. This task can typically be performed in the framework of Markov Decision Processes (MDP), which can be trained through imitation or reinforcement learning. The exponential size of a state space for MDPs, which is inherent to the NP-hardness of combinatorial problems, usually precludes using other methods such as (tabular) dynamic programming.

Regardless of the learning method used to solve the MDP, its efficiency, including its out-of-distribution generalization capabilities, greatly depends on the state representation. The present inventors have recognized that the state space is often characterized by deep symmetries, which, if they are not adequately identified and leveraged, can hinder the training process by forcing it to independently learn the optimal policy at states which in fact are essentially the same.

Design choices have a considerable impact when solving the MDP. Exploiting the COP's symmetries can boost the efficiency and generalization of neural solvers. Example systems and methods herein can be used to cast essentially any COP as an MDP, which can in turn be used to account for common COPs' symmetries to provide a more efficient MDP.

For example, given a user-defined solution space for a COP, a corresponding MDP, referred to herein as a direct MDP, can be derived, e.g., automatically, where the state is a partial solution, and the actions are construction steps. Example systems and methods can further be used to derive and implement an MDP for any COP to exploit the recognized equivalence between the optimal policies and solving the COP.

Example systems and methods can address the limitations of previous methods that use the partial solutions of COPs as states in MDPs by introducing a mapping, referred to herein as a bisimulation mapping, to reduce the state space. For COPs that satisfy a recursive property, described below, example methods can map a partial solution to a new (induced) instance, which corresponds to the remaining COP subproblem when the partial solution is fixed. Since many partial solutions can induce the same instance, the resulting MDP, which in example methods herein is referred to as a bisimulation quotiented MDP or BQ-MDP, has significantly smaller state space. Further, such mapping enables more efficient learning by avoiding the need to independently learn the policy at states which are equivalent for the COP at hand. These exploited symmetries can be linked to the recursive property of the problems, which is common in CO and includes the Optimality Principle of dynamic programming.

To illustrate example features and benefits, example methods and systems are described herein for example frameworks including well-known COPs such as the Traveling Salesman Problem (TSP), the Capacitated Vehicle Routing Problem (CVRP), the Knapsack Problem (KP), and a multi-agent task assignment problem (MATAP). Neural network architectures, such as attention-based (e.g., Transformer-based) architectures are presented for example frameworks that are well-suited for BQ-MDPs.

The policy may be trained, as nonlimiting examples, by reinforcement learning, or by imitation of expert trajectories derived from (near) optimal solutions of small instances of a single distribution. However, the trained policy may be used to solve COPs of the distribution used for training as well as other distributions, e.g., COPs of a significantly larger size. Example models were tested on both synthetic and realistic benchmarks of varying size and node distributions.

In some example embodiments, performance can be further improved using a beam-search, which requires more computation. Further, in some example embodiments, one can significantly speed up the execution, at the cost of a slight performance drop, by replacing the (quadratic) transformer model with a linear attention-based model, such as the PerceiverIO, e.g., as disclosed in Jaegle et al., Perceiver IO: A General Architecture for Structured Inputs & Outputs, In International Conference on Learning Representations, January 2022.

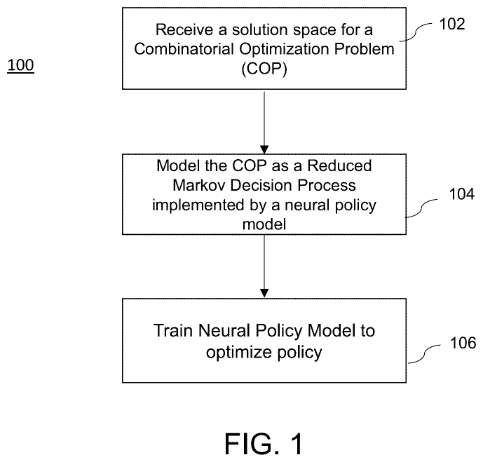

Referring now to the drawings, FIG. 1 shows an example method 100 for training a neural network to solve a Combinatorial Optimization Problem (COP). A solution space is received for the COP at 102. The solution space is provided by the set of partial solutions for the COP, where each partial solution includes a sequence of one or more steps. The COP is modeled at 104 as a reduced Markov Decision Process over the solution space using a neural policy model.

The neural policy model is configured to generate a sequence of actions over a plurality of time steps (e.g., one generated action per time step) to provide an outcome. The outcome may be, for instance, an outcome of a trajectory of generated actions, as explained in further detail below. Partial solutions, e.g., partial outcomes or a subsequence of actions, may also be determined by the neural policy model, and accordingly a sequence of actions can include one or more actions up to and including a partial or complete sequence. Sequences may or may not be temporal or chronological, depending on the COP, and nonlimiting examples of chronological and non-chronological sequences are provided herein. The neural policy model includes (e.g., may be defined by) a set of trainable (updatable) policy parameters.

The neural policy model is trained at 106 to optimize the policy. For instance, the policy parameters may be initialized and updated to minimize a loss or maximize a reward. Example training methods include reinforcement learning (RL) or imitation learning by comparing outcomes generated by the neural policy model for training on COP instances taken from a distribution to expert trajectories.

### Modeling a Combinatorial Optimization Problem as a Reduced Markov Decision Process

To model the COP as a reduced Markov Decision Process, the COP may be modeled as a corresponding direct MDP for solving the COP. The direct MDP may be mapped to a reduced MDP, which may be implemented by a neural policy model to exploit symmetries in the direct MDP. An example modeling method will now be described.

Modeling a COP Instance and Solution Space: Methods for representing (modeling) a COP as an MDP amenable to machine learning techniques (step 104) and methods for training a neural policy model (step 106) will now be described. Although several example COPs are provided herein for illustrating inventive features, it will be appreciated that example methods and network architectures herein are similarly applicable to solve other COPs.

Formally, a COP instance can be denoted by:

$$arg {min}_{x ∈ X} f ( x ) ,$$

where X is the finite, non-empty set of feasible solutions, and the objective ƒ is a real-valued function whose domain contains X. The complexity of the COP is due to the cardinality of X, which, although finite, is generally exponential in the length of the instance description (the problem size).

Constructive approaches to CO build a solution sequentially by growing a partial solution at each step. A required, though often implicit, assumption of constructive heuristics is that the feasibility of the final solution can be ensured through conditions on the partial solutions at each step of the construction process.

Denote by [symbol] the set of all partial solutions for a given COP, where the set of all partial solutions [symbol] encompasses the set of feasible solutions X and is amenable to a Non-deterministic Polynomial (NP) stepwise construction procedure. Each step chooses among a polynomial number of options, and the number of steps is itself polynomial in the description length.

The set of all partial solutions [symbol] contains the feasible solutions of any COP instance. It can be assumed that [symbol] is equipped with a (binary) operation · and a neutral or null element ∈. Informally, ∈ is the “empty” partial solution at the beginning of each construction; and if x, y are partial solutions, then x·y denotes the object obtained by applying the sequence of construction steps yielding x followed by that yielding y.

Denote by [symbol] the subset of partial solutions (a subset of [symbol] ) obtained by just one construction step. The elements of [symbol] are referred to herein as steps, and it can be assumed that any partial (feasible) solution can be obtained as the composition of a sequence of steps.

A solution space of the COP can be defined as a tuple ( [symbol] , ·, ∈, ⊥, [symbol] ) where ( [symbol] , ·, ∈, ⊥) forms a monoid with zero, and the step set [symbol] ⊂ [symbol] (whose elements are steps) is a generator of the set of partial solutions [symbol] , such that any elements of [symbol] have a finite number of step decompositions:

$$∀ x ∈ X , 0 < \vert \{ {z}_{1 : n} ∈ {𝒵}^{n} : x = {z}_{1} ∘ … ∘ {z}_{n} \} \vert < ∞ \qquad ( 1 )$$

Thus, solving a COP instance (ƒ, X) given a solution space of all partial solutions [symbol] containing the subset of all feasible solution X can amount to finding the correct sequence of steps z_{1:n}, such that

$${z}_{1} ∘ … ∘ {z}_{n} ∈ arg {min}_{x ∈ X} f ( x ) .$$

This task can naturally be modeled as an MDP.

The same MDP should be applicable to all the instances of a CO problem, and thus the solution space should be defined problem-wise (for a goal-directed MDP), or even apply to multiple problems (for a multi-task MDP). This usually imposes that Z and [symbol] be infinite, in order to accommodate instances of finite but unbounded size, but the finiteness condition in equation (1) above can avoid the pitfalls which may result.

### Representing the COP by a Direct MDP

Given a solution space ( [symbol] , ·, ∈, ⊥, [symbol] ), consider the set [symbol] [symbol] of COP instances (ƒ, X) where the set of feasible solutions X is a finite, non-empty subset of [symbol] , and the objective function ƒ∈ [symbol] [symbol] is well-defined for any partial solution (not just the feasible ones), i.e., defined on the set of partial solutions [symbol] rather than just the set of feasible solutions X. Given such a COP instance (ƒ, X)∈ [symbol] [symbol] , one can derive its direct MDP, denoted [symbol] _{(ƒ, X)}, as follows.

A state space for the direct MDP is the set X̅={x∈ [symbol] : ∃y∈ [symbol] , x·y∈X} of partial solutions which can potentially be expanded into a feasible one. The action space is [symbol] ∪{∈}, i.e., an action is either a step or the neutral action. The transitions are deterministic, and can be represented as a labeled transition system according to the following two rules, where the label of each transition includes its action-reward pair, placed respectively above and below the transition arrow:

$$x {{⟶}_{f ( x ) - f ( xo \text{?} )}}^{\text{?}} xo \text{?} if xo \text{?} ∈ \overline{X} and x {{⟶}_{0}}^{ϵ} x if x ∈ X \qquad ( 2 )$$

$$\text{?} \text{indicates text missing or illegible when filed}$$

In Eqn. (2), above, x∈X̅ is a state and z∈ [symbol] is a step. The condition in each rule determines whether the action is allowed. Due to the structure of the solution space captured by the definition above, the direct MDP [symbol] _{(ƒ, X)} of a COP instance (ƒ, X) can be shown to have at least three significant properties:

(1) From any state, the number of allowed actions is finite (even if [symbol] is infinite), and therefore the direct MDP [symbol] _{(ƒ, X)} belongs to the simpler class of discrete-action MDPs. The empty partial solution e is a valid state.

(2) From any state, there is always at least one allowed action; that is, there are no dead-end states. This assumes that one can guarantee whether a partial solution can be expanded into a feasible one, as required of the valid states in X̅. This assumption in constructive heuristics allows one to avoid the complications associated with dead ends in MDPs.

(3) In any infinite trajectory in [symbol] _{(ƒ, X)}, the number of transitions involving a step action is finite, while all the other transitions involve the neutral action. Since the neutral action yields a null reward, this means that the return of a trajectory is well defined, without having to discount the rewards. Also, if a_{1:∞} is the (infinite) sequence of actions of the trajectory, since all but finitely many of them are neutral actions, their (infinite) composition a₁·a₂· . . . is well-defined and can be referred to as the outcome of the trajectory, and is its stationary state. The outcome of a trajectory starting at the null state e is also its stationary state.

It can be shown that, given a solution space [symbol] and an instance (ƒ, X)∈ [symbol] [symbol] , its direct MDP can be represented as [symbol] _{(ƒ, X)}. The set

$$arg {min}_{x ∈ X} f ( x )$$

is exactly the set of x such that there exists an optimal policy π for M_{(ƒ, X)} where x is the outcome of a trajectory starting at ∈ under policy π.

The above result establishes an exact correspondence between the optimal solutions of a COP instance and the optimal policies of its direct MDP. Accordingly, the vast corpus of techniques available to search for optimal policies in MDPs in general is applicable to solving COPs in example methods. It will be appreciated that direct MDPs as provided herein encompass many existing MDPs where the state is a partial solution and each action consists of adding an element to the partial solutions, e.g., graph problems, the TSP problem, etc. and may further be applicable to to-be known COPs.

### Mapping the Direct MDP to the Reduced MDP

State Information and Symmetries: Let ( [symbol] , ·, ∈, ⊥, [symbol] ) be a solution space and [symbol] _{(ƒ, X)} the direct MDP of a COP instance (ƒ, X)∈ [symbol] [symbol] . In a trajectory of [symbol] _{(ƒ, X)}, each step transition (action) “grows” the state from x to x·z where z is the selected step action. In many COP instances, this may be counter-intuitive, because it implies that the state information increases while the number of allowed actions decreases. For example, in the TSP, the state contains the sequence of all the visited nodes, which grows at each step, while the allowed actions belong to the set of unvisited nodes, which shrinks at each step. At the end, the state may carry the most information (a full-grown feasible solution), but it is not used at all in any decision, since there is a single allowed action anyway (the null action).

It is thus useful in example methods herein to define a new state which captures only the information needed for the continuation of the construction process. To do so, it is observed that a partial solution y∈ [symbol] can be seen both as an operator on partial solutions x [symbol] H, x·y which grows its operand, or, dually, as an operator on instances which reduces its operand:

$$( f , X ) ↦ ( f * y , X * y ) with : ( f * y ) ( x ) = f ( y ∘ x ) and x * y = \{ x \vert y ∘ x ∈ X \} .$$

In the above, (ƒ*y, X*y) is the so-called tail subproblem of instance (ƒ, X) after partial solution y has already been constructed. For a given tail subproblem [symbol] (ƒ′, X′), there can be many combinations of instances (ƒ, X)∈ [symbol] [symbol] and partial solutions x∈X̅ such that (ƒ*x, X*x)=(ƒ′, X′).

Reducing the Direct MDP Using Bisimulation: To leverage the above reduction operation and the potential symmetries, a “reduced” MDP [symbol] is presented for efficiency enhancement. In the reduced MDP, the state space is the set [symbol] [symbol] of instances, and the action space is [symbol] ∪{∈}, as in the direct MDP. The transitions are also deterministic, and can be expressed using two rules, which correspond to the rules in Equation (2) above:

$$( f , X ) {{⟶}_{j ( x ) - f ( xo \text{?} )}}^{\text{?}} ( f ⋆ 𝓏 , X ⋆ 𝓏 ) if X * \text{?} \neq ∅ and ( f , X ) = {{⟶}_{0}}^{ϵ} ( f \text{?} X ) if ∈ X . \qquad ( 3 )$$

$$\text{?} \text{indicates text missing or illegible when filed}$$

The reduced MDP can be defined at the level of the whole solution space rather than an individual instance, as in the direct MDP.

To link the direct MDP [symbol] _{(ƒ,} [symbol] ₎ to the reduced MDP, a mapping Φ from the direct to the reduced states is provided, where Φ_{(ƒ, X)}(x)=(ƒ*x, X*x) for all x∈X̅. This mapping Φ may be referred to as a bisimulation, in that for any direct state x, the action-reward sequences spawned from x in M_{(ƒ, X)} and from Φ_{(ƒ, X)}(x) in [symbol] are identical. Therefore, there exists a correspondence between the trajectories of [symbol] _{(ƒ, X)} starting at ∈ and the trajectories of [symbol] starting at Φ_{(ƒ, X)}(∈)=(ƒ, X).

Formally, [symbol] is the so-called quotient of the direct MDP by the bisimulation Φ. Accordingly, the quotient is referred to as BQ-MDP, and thus example reduced MDPs provided herein can be embodied in BQ-MDPs.

An analogue of the above proposition for the direct MDP can be provided for the BQ-MDP. Let [symbol] be the BQ-MDP of a solution space [symbol] , and (ƒ, X)∈ [symbol] [symbol] an instance. The set

$$arg {min}_{x ∈ X} f ( x )$$

is exactly the set of x such that there exists an optimal policy π for [symbol] where x is the outcome of a trajectory starting at (ƒ, X) under policy π.

### Example COPs

TSP. In an example COP, the (Euclidean) Traveling Salesman Problem (TSP), a COP instance may be defined by a set of nodes, which are points in a Euclidean space. The goal of the TSP is to find the shortest tour which visits each node exactly once. A partial solution for the TSP can be represented by a sequence of nodes. The set of partial solutions [symbol] _{TSP} can thus be defined as the set of finite sequences of nodes. For TSP, the operator · is sequence concatenation, the neutral element ∈ is the empty sequence, and a step is a sequence of length 1.

In the TSP, the tail subproblem involves finding the shortest path, from the last node (vₗₐₛₜ) of the partial solution to its first node (v_{first}), which visits all the not-yet-visited nodes. It can thus be seen that, given the set of unvisited nodes, any node sequence that gives a path from v_{first} to Vₗₐₛₜ will lead to the same tail subproblem. This provides a strong symmetry with respect to the MDP policy: an optimal policy should produce the same action for all these partial solutions. Treating them as distinct states, as in the example direct MDP, forces a training procedure to learn the underlying symmetry to map them into a common representation.

CVRP: Another example COP, the Capacitated Vehicle Routing Problem (CVRP), is a vehicle routing problem in which a vehicle with limited capacity must deliver items from a depot location to various customer locations. Each customer has an associated demand, and the goal is to compute a set of subtours for the vehicle, starting and ending at the depot, such that all the customers are visited, the sum of the demands per subtour of the vehicle does not exceed the capacity, and the total traveled distance is minimized. CVRP is a generalization of the TSP where each customer node also has an associated demand feature, and the vehicle has a fixed capacity.

Generally, the COP instance for the CVRP may be defined by a capacity and a set of nodes, including a depot, which are points in a Euclidean space, where each of the set of nodes other than the depot is associated with a demand (which demand can be zero). The set of partial solutions [symbol] _{CVRP} and the objective (travelled distance) may be the same as with the TSP. Formally, a partial solution (in [symbol] ) for CVRP is a finite sequence of nodes, as with the TSP. The · operator is sequence concatenation, and the neutral element ∈ is the empty sequence. In a CVRP instance, each node is assigned a location, and the objective function ƒ for an arbitrary sequence of nodes is the total traveled distance for a vehicle visiting the nodes in sequence:

$$f ( {x}_{1 : n} ) = {\sum }_{i = 2}^{n} dist ( {x}_{i - 1} , {x}_{i} ) \text{?}$$

$$\text{?} \text{indicates text missing or illegible when filed}$$

The feasible set X consists of the sequences x_{1:n} of nodes which start and end at the depot, which are pairwise distinct except for the depot, and such that the cumulated demand of any contiguous subsequence x_{i:j} not visiting the depot; i.e., a segment of a subtour, does not exceed the capacity of the vehicle:

$${x}_{1 : n} ∈ X \text{?} \{ \begin{matrix}{x}_{1} = {x}_{n} = depot , & \\ ∀ i , j ∈ \{ 1 : n \} & {x}_{i} = {x}_{j} \neq depot ⟹ i = j , \\ ∀ i , j ∈ \{ 1 : n \} & ∀ k ∈ \{ i : j \} {x}_{k} \neq depot ⟹ {\sum }_{k - i}^{j ,} demand ( {x}_{k} ) \leq capacity\end{matrix} .$$

$$\text{?} \text{indicates text missing or illegible when filed}$$

KP: In another example COP, the Knapsack Problem (KP), the COP instance is defined by a finite set of items which are points in a space with weight and value features, where the goal is to select a subset of these items such that the sum of their weights does not exceed a given capacity while their cumulative value is maximized. [symbol] _{KP} can be defined as the set of finite subsets of items which are points in the feature space. Similarly, for KP, the operator · is a set union, the neutral element ∈ is the empty set, and a step is a set of length 1.

MATAP: In another example COP, a multi-agent task assignment problem (MATAP), the COP instance may be defined by a set of tasks, a set of agents, an agent duration to reach each task and to switch between tasks for each agent, a processing duration for each task, date parameters, and a feasibility constraint on plans. A plan is an assignment of a finite (possibly empty) sequence of tasks to each of a set of agents, satisfying an order consistency condition. A goal of the MATAP is to find a plan which satisfies the feasibility constraint and minimizes some objective involving only the completion date of each task. The solution space may be the set of plans. Operator · for the MATAP is agent-wise sequence concatenation, where each agent is assigned the concatenation of the sequences of tasks assigned to it in the two operands, the neutral element ∈ is the empty plan assigning the empty sequence of tasks to all the agents, and a step may be a plan in which exactly one task is visited by one or more agents. The parametrization of MATAP where the feasibility constraint on plans is unrestricted is tail-recursive. However, it is intractable, meaning that it is not easy to decide whether a partial solution can eventually be expanded into a feasible one. Various restrictions on the feasibility constraint lead to sub-problems of MATAP which satisfy both tail-recursion and tractability. An example of restriction which ensures tail-recursion and tractability allows only feasibility constraints which constrain the crew of agents visiting each task to belong to a predefined set of crews of agents for that task. More relaxed restrictions on the feasibility constraint of MATAP also lead to parametrizations which ensure both tail-recursion and tractability.

Though the above example problems use set or sequence- (or list-) based solution spaces, other solution spaces (e.g., graph-based) are possible. Generally, a solution space is not intrinsic to a COP (Combinatorial Optimization Problem), nor vice-versa.

### Model Architectures for BQ-MDPs

Although both the direct MDPs and reduced MDPs (e.g., BQ-MDPs) are equivalent in terms of solving their associated COP, their practical interpretation leads to significant and useful differences. In the direct MDP view, it would not be practical to learn each instance-specific MDP separately. Instead, a generic MDP conditioned on an input instance can be learnt, similar to goal-conditioned reinforcement learning, where the goal is the input instance.

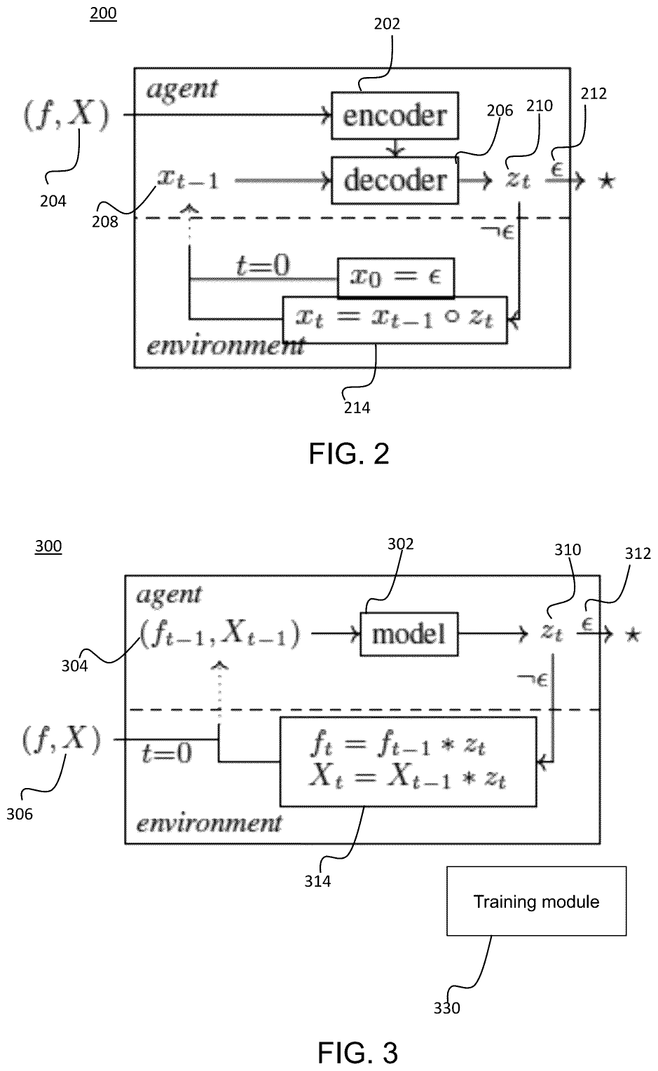

For comparison, a policy architecture 200 for implementing a direct MDP, shown in FIG. 2, includes an encoder 202 configured to compute an embedding of a COP input instance 204 and a decoder 206 that takes the instance's embedding and the current state 208, respectively to compute the next action, e.g., a step 210 or a neutral action 212. The encoder 202 and the decoder 206 may be considered to provide an agent that determines an action in an environment. The encoder 202 and decoder 206 typically involve some form of self-attention, while the decoder 206 typically also uses cross-attention to incorporate the instance embedding output by the encoder 202. For example, the example encoder 202 and decoder 206 may be embodied in an attention model, e.g., as disclosed in Kool et al., Attention, Learn to Solve Routing Problems! In International Conference on Learning Representations, 2019; or PointerNetworks, e.g., as disclosed in Vinyals et al., Pointer Networks, In Advances in Neural Information, Processing Systems 28, pages 2692-2700, 2015.

The current state 208, i.e., the partial solution x, is updated at an updating block 214 in the environment. In the rollout of a trajectory, the encoder 202 needs only to be invoked once, since the COP instance 204 (ƒ, X) does not change throughout the rollout.

By contrast, FIG. 3 shows a policy architecture 300 for implementing the reduced MDP, e.g., the BQ-MDP. The policy architecture 300 includes a neural policy model 302 configured to compute an embedding of a COP input instance 304, which is provided by an initial COP instance 306 at an initial time step t=1 and an updated COP instance from the previous time step t=t−1 for all time steps t>1 (in this regard, the initial COP instance can be considered the COP instance updated at time t=0). The neural policy model 302 that takes the instance's 304 embedding, which provides a current state, to compute the next action, e.g., a step 310 or a neutral action 312. The neural policy model 302 may be considered to provide an agent that determines an action in an environment.

The current state 304, i.e., the COP instance (ƒₜ₋₁, Xₜ₋₁), is updated at an updating block 314 in the environment based on the determined step 310 if a step is determined. More particularly, if the step 310 is determined by the neural policy model 302, the updating block 314 updates both the objective ƒₜ₋₁ and the set of feasible solutions Xₜ₋₁. The entire neural policy model 302 is applied to a new input instance 304 at each time step t of a rollout.

In the BQ-MDP policy architecture 300, only one, unconditional MDP (implemented by neural policy model 302) is learnt for the whole solution space. The neural policy model 302, which may be self-attention based, can be simpler, e.g., than the encoder and decoder 202, 206 since the distinction between encoder and decoder vanishes in the neural policy model 302, though it is not required that the neural policy model be simpler than the encoder and decoder 202, 206 in a direct MDP.

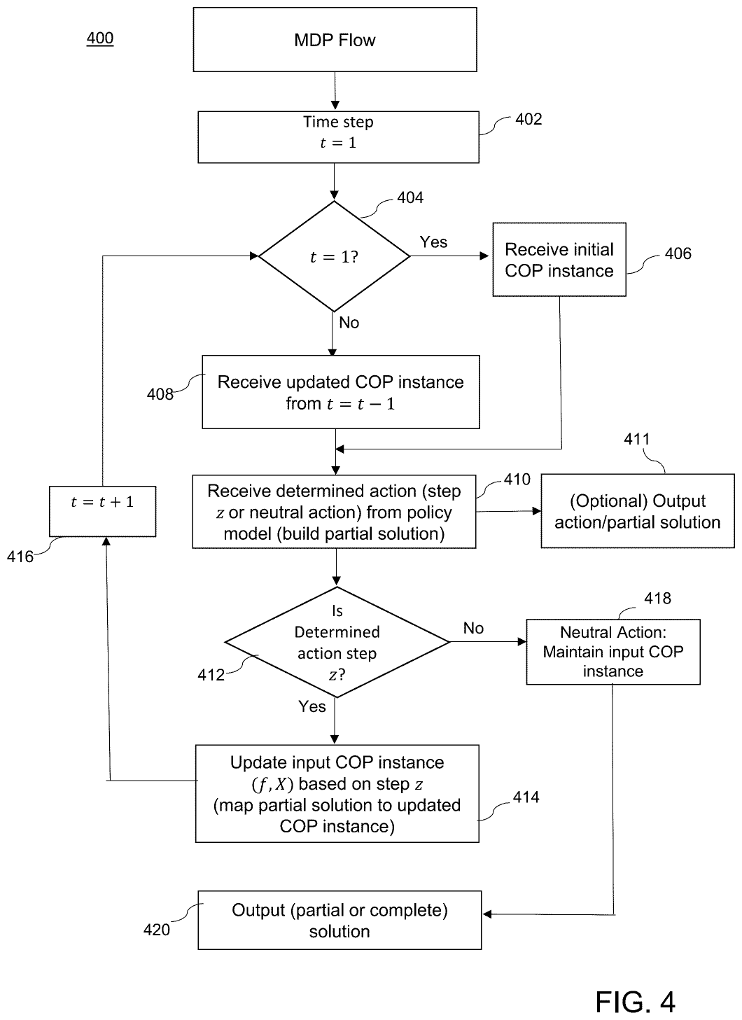

FIG. 4 shows an example method 400 for information flow in a reduced MDP, such as a BQ-MDP. In the example method, a time step is initialized at 402. If it is the initial time step t=1 at 404, an initial COP instance is received as an input COP instance at 406, such as by the neural policy model 302, e.g., via an embedding layer in a neural network. If it is a subsequent time step t>1, the COP instance updated in the previous time step t−1 is received at 408 as the input COP instance. The neural policy model determines an action at 410, which is either a next step z or a neutral action.

This next determined action from the policy model at step 410 may be, but need not be, output, e.g., as a partial solution, at 411. This determined action or partial solution may be provided, e.g., for causing a device including but not limited to those provided herein to perform the determined action(s), for use in one or more downstream operations (e.g., incorporation into a larger sequence of actions, processing or analyzing the determined action, communicating the determined action, combining the determined action with other actions), for storage (e.g., in non-transitory memory, in working memory, etc.), etc. at any time during or after the completion process 400, including but not limited to before a complete solution (e.g., the sequence of actions) is determined (e.g., as one or more intermediate actions) or after the complete solution is determined.

The determined action may be received, e.g., by an instance updating block such as instance updating block 314, while the determined neutral action may be received as an output. If the determined action is a step z at 412, the input COP instance is updated based on the next step z at 414, and the updated COP instance is provided at a next time step. The time step is then incremented (t+1) at 416. If the determined action is not next step z, i.e., it is the neutral action, the input COP instance is maintained at 418, and the solution, e.g., the sequence of steps z (outcome) determined from time steps 1 . . . n, where n is the step in which the neutral action is determined, may be output at 420 (if prior determined actions have been previously output as one or more partial solutions, the final step z may be output at 420 to provide the complete solution). The output solution at 420 may be provided, e.g., for causing a device including but not limited to those provided herein to perform the determined action(s), for use in one or more downstream operations (e.g., incorporation into a larger sequence of actions, processing or analyzing the determined action, communicating the determined action, combining the determined action with other actions), for storage (e.g., in non-transitory memory, in working memory, etc.), etc., and/or may be used for training the neural policy model, as described in further detail herein with reference to FIG. 8.

### COP Instance Parametrization and Tail-Recursion

For a given COP, COP instances are generally defined by a set of parameters, and these parameters are used as the input to a policy network, which may be embodied in or include a neural network. In the example BQ-MDP, the instance is updated at each step z, e.g., according to the equations ƒ′=ƒ*z and X′=X*z.

To implement the BQ-MDP, it is useful that (ƒ′, X′) can be represented in the same parametric space as (ƒ, X). This is the case for COPs that satisfy a recursive property, e.g., a tail-recursion property, namely, problems where after applying a number of construction steps z to an instance, the remaining tail problem is itself an instance of the original COP. The tail-recursion property is common in COP, including the Optimality Principle of Dynamic Programming. In general, all problems that are amenable to dynamic programming satisfy the tail-recursion property. COPs satisfying a tail-recursion property are referred to herein as tail-recursive COPs. For tail-recursive COPs, the example bisimulation can simply map a partial solution, e.g., partial solution x, to the sub-instance it induces, e.g., updated COP instance (ƒ, X).

For example, the TSP, CVRP, KP, and MATAP, as well as many of their variants, either are or may be configured, modified, or adapted, e.g., using methods such as provided herein, to be recursive, e.g., tail-recursive. For example, although some COPs based on TSP and CVRP may not be directly tail-recursive, they may be tail-recursive when however they are configured, modified, or adapted to be sub-problems of a larger, tail-recursive problem, examples of which are referred to herein as path-TSP and path-CVRP, respectively, which do satisfy the Optimality Principle.

For the TSP, a more general problem can be considered. After constructing a partial path (o, x₁, . . . , xₖ), the tail subproblem finds the shortest path from xₖ to o that visits all the remaining nodes. By considering a corresponding MDP, an example of which is referred to as path-TSP, where a path from a given origin to a given destination is sought instead of a tour, the original instance can be viewed as a path-TSP instance with both origin and destination at o, whereas the tail subproblem is a path-TSP instance with origin at xₖ and destination at o.

A similar reasoning holds for the CVRP as with the TSP, and thus a corresponding reduced MDP may be considered. As with TSP, CVRP on its own does not satisfy the tail-recursion property described above, but CVRP is a particular case of a more general problem, referred to herein as path-CVRP, that does satisfy the tail-recursion property. In path-CVRP, instead of starting at the depot with its full capacity, the vehicle starts at an origin node with a given initial capacity. A CVRP instance is a path-CVRP instance where origin and depot are the same and the initial capacity is the full capacity. In path-CVRP, each tail subproblem after selection of a node z updates both the origin (which becomes z) and the initial capacity (which is decremented by the demand at z if z is a customer node or reset to the full capacity if z is the depot), conditioned on the resulting capacity being non-negative.

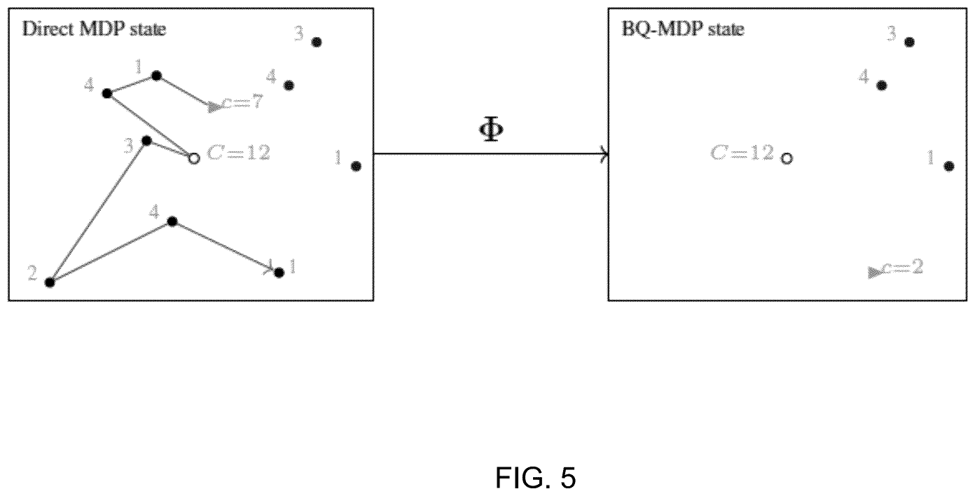

To provide the reduced MDP (e.g., BQ-MDP) for path-CVRP, given the above solution space, one can directly apply the BQ-MDP definitions given above. An example application is illustrated in FIG. 5. FIG. 5, left, represents a direct MDP state, which is a path-CVRP instance together with a partial solution. The depot is represented as an open disk with its full capacity (C=12), the origin as a triangle with initial capacity (c=7), and customer nodes as (closed) dark (previously visited) or blue (to-be-visited) disks with their demands. The partial solution is the sequence of dark nodes represented by the (directed) line-based path.

FIG. 5, right, represents the corresponding reduced MDP (BQ-MDP) state, which is a path-CVRP instance. This figure shows the new origin (the end node of the partial solution), and its initial capacity c=2; this is the full capacity C=12 minus the cumulated demand served since the last visit to the depot (3+2+4+1).

The Knapsack Problem (KP) is an example of a COP that naturally satisfies the tail-recursion property. Consider an instance of the KP (an example COP instance) with items I={(w₁, v₁), . . . , (wₙ, vₙ)} and capacity C. A partial solution at step k can be defined as sₖ={(w_{σ(1)}, v_{σ(1)}), . . . , (w_{σ(k)}, v_{σ(k)})}. The example bisimulation Φ maps sₖ to a new KP instance with the set of items I\sₖ, and capacity C−(w_{σ(1)}+ . . . +w_{σ(k)}).

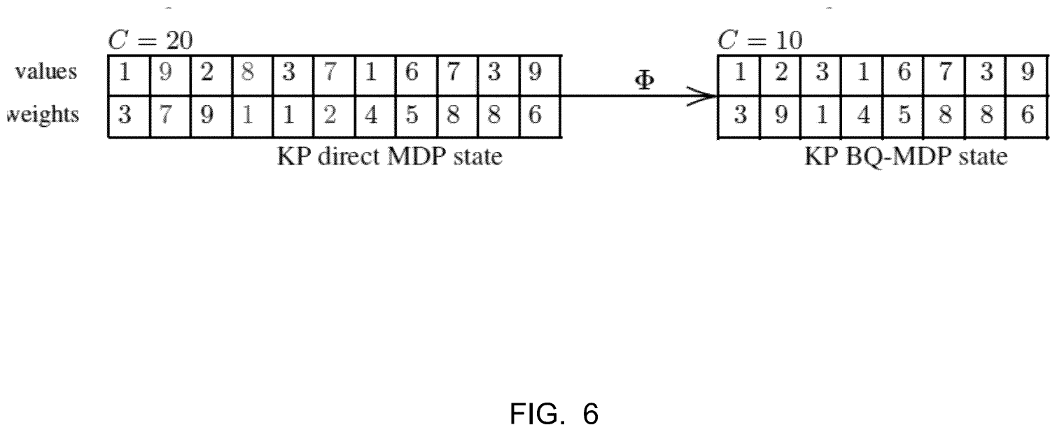

FIG. 6 illustrates an example of the KP direct MDP state mapped to a reduced KP (KP BQ-MDP) state, including capacities, values, and weights. In the example, the knapsack capacity is C=20 and each item is defined by its weight (bottom cell in the figure) and value (top cell). The mapping Φ to the BQ-MDP state for KP includes removing all picked items and updating the remaining capacity by subtracting the total weight of removed items from the previous capacity.

### Policy Networks

Example transformer-based policy networks, e.g., providing the neural policy model 302, will now be described for illustrating example features.

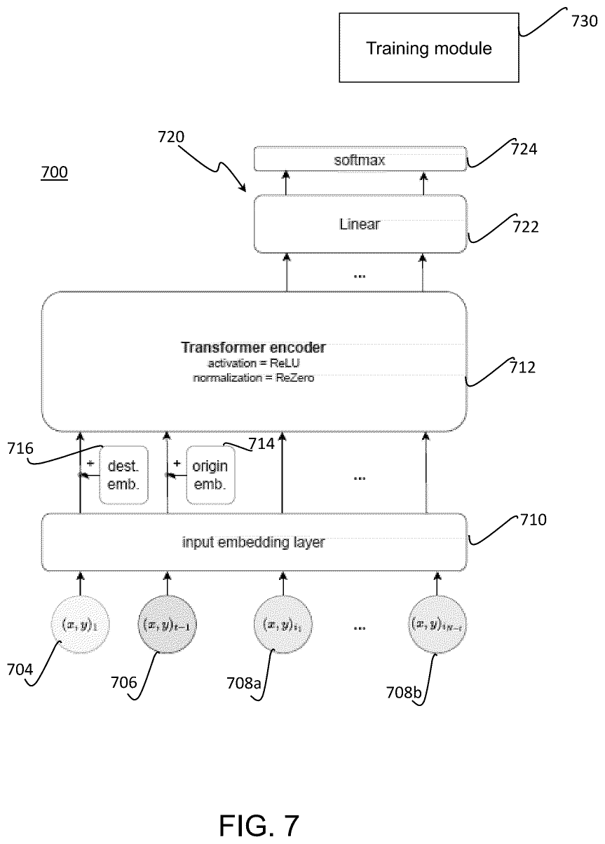

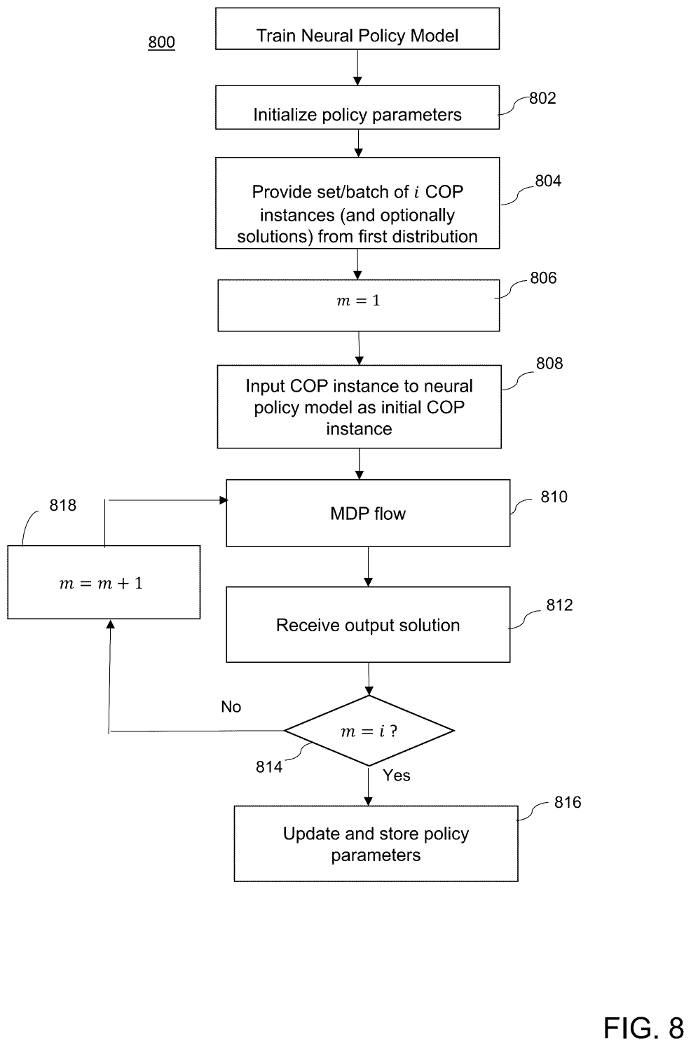

FIG. 7 shows an example neural architecture 700 providing a policy model for Path-TSP. In FIG. 7, computation flow is shown at the t-th time step, when a partial solution of length t−1 already exists. In the example neural architecture 700, each node, including the origin 704 (i.e., the most recent node in the tour), destination 706 (i.e., the first and last node in the TSP tour), and remaining nodes 708a, 708b, may be represented by its (e.g., Euclidean, or (x, y)) coordinates and embedded via a (linear) input embedding layer 710.

The example neural architecture 700 may include or be based on the attention-based model disclosed in Vaswani et al., Attention is All you Need. In Advances in Neural Information Processing Systems, volume 30, 2017 and in U.S. Pat. No. 10,452,978, issued Oct. 22, 2019, including a transformer encoder 712, but with certain possible differences. One difference, however, is that the example network model 700 does not need to include an autoregressive decoder (though it still can in some embodiments). Another difference is that the example network model 700 for Path-TSP need not use positional encoding, since the input nodes have no order. Instead, an origin embedding 714 (e.g., a special, learnable vector embedding) may be added to the feature embedding of the origin node 704, and a destination embedding 716 (e.g., a special, learnable vector embedding) may be added to the feature embedding of the destination node 706, to signal their special meanings. Normalization, e.g., ReZero normalization, as disclosed in Bachlechner et al., ReZero is all you need: Fast convergence at large depth, In Proceedings of the Thirty-Seventh Conference on Uncertainty in Artificial Intelligence, pages 1352-1361. PMLR, December 2021, may be provided in the encoder 712 for providing more stable training and improved performance.

A linear classifier head 720 that selects the next node at step t may include a linear layer 722 that projects the output of the last attention block of the transformer encoder 712 into a vector of size N, from which unfeasible actions, corresponding to the origin and destination nodes 704, 706, are masked out, before applying an operator or classifier, e.g., softmax 724, to interpret the (scalar) node values for all allowed nodes as action probabilities.

The input state in the example network model 700 includes the (shown leftmost) destination node (i.e., the first and last node in the TSP tour), the (shown second leftmost) origin node (i.e., the most recent node in the tour) and the set of remaining nodes. After passing all input nodes through an embedding layer, special, learnable vector embeddings are added to the origin and current node to signal their special meaning. An encoder, e.g., a Transformer encoder, followed by a linear classifier head selects the next node at step t.

Example architectures for other example tail-recursive COPs, including CVRP (path-CVRP), KP, and MATAP may be generally similar to the example architecture 700 for path-TSP, but with certain example differences, as provided in more detail below with reference to example embodiments below. An example model architecture for the CVRP can be, for instance, nearly identical to the model architecture 700 for TSP, but may include differences in the input and output layers, e.g., 710, 724. In an example TSP policy model, the input to the node embedding layer 710 for an N-node state may be a 2×N matrix of coordinates. For CVRP, on the other hand, two additional channels may be used: one for the node's demand, and one for the current vehicle capacity, repeated across all nodes. The demand may be set to zero for the origin and depot nodes. A 4×N matrix of features may be thus obtained, which is passed through a learned embedding layer. As with the example TSP model 700, a learned origin 714 and depot 716 embedding, e.g., a token vector, may be added to the corresponding node embeddings.

The remainder of the example model architecture may be (for instance) similar or identical to the model architecture 700 for TSP, until after the action scores projection layer. For TSP, the projection layer, e.g., linear layer 722, can return a vector of N scores, where each score, after a softmax or other prediction activation operator, e.g., softmax layer 724, represents the probability of choosing that node as the next step in the construction. For CVRP, on the other hand, the policy model, e.g., the projection layer, may return a matrix of scores of dimension N×2, corresponding to each possible action, and the softmax or other prediction activation operator may scope over this entire matrix. An action in this example model is either the choice of the next node, as in TSP, or of the next two nodes, the first one being the depot.

In the CVRP model, as with the TSP model, a mask may be applied to unfeasible actions, e.g., before the softmax operator 724. Unfeasible actions for CVRP can include those which have higher demand than the remaining vehicle capacity, as well as the origin and depot nodes.

The example model architecture for KP can be, for instance, similar to the example model architectures for TSP 700 and for CVPR, with example differences provided herein. An input to the example KP model architecture is a 3×N (for instance) tensor composed of item features (values, weights) and an additional channel for the remaining knapsack's capacity. In a typical knapsack problem, the solution has no order, as the result is a set of items, so it is not necessary to add tokens such as tokens 714, 716 for origin and destination. Other than excluding these tokens and the different input dimensions, the remainder of the example KP model architecture may be identical to the example TSP model architecture 700 provided herein, though other variations are possible. The output of the example KP model is a vector of N probabilities over all items, with a mask over the unfeasible ones (e.g., with weights larger than the remaining knapsack's capacity).

### Training the Policy Model

In an example training method, at each construction step, any item of the ground-truth solution is a valid choice, and thus an example training method for the KP model uses a multi-class cross-entropy loss. FIG. 8 shows an example method 800 for training a neural policy model, such as model 700 (or variants thereof), or policy model 302. The training method 800 may be performed, for instance, by a training module 330 connected to architecture 300, or by a training module 730 connected to architecture 700.

An example training method 800 trains the policy model 302, 700 by imitation learning, namely by imitation of expert trajectories, using for instance a cross-entropy loss. Trajectories may be extracted, for example, from pre-computed (near) optimal solutions for COP instances, such as COP instances from a first distribution, e.g., a set of COP instances having a relatively small and fixed size. This is advantageous, as it is generally possible to efficiently solve small instances (e.g., using mixed-integer linear programming (MILP) solvers).

Optimal solutions are not directly in the form of trajectories, i.e., sequences of construction steps, since while Equation (1) above guarantees that a trajectory exists for any solution, it is usually not unique. For example, in the TSP, an optimal tour corresponds to two possible trajectories, one being the reverse of the other. In the CVRP, each subtour similarly corresponds to two possible trajectories, and further the different orders of the subtours lead to different trajectories. While the final order may impact the model's performance, any sub-sequence from a fixed trajectory can be interpreted as the solution of a sub-instance. As these sub-instances vary both in size and node distribution, training on them implicitly encourages the policy model 302, to work well across sizes and node distributions, and the policy model generalizes better than if such variations were not seen during the training.

In an example training method 800, policy parameters may be initialized at 602 using any suitable initialization, e.g., randomization, set to a same initial value, based in part on prior information or prior training, or any other method. A set or batch of i COP instances are provided at 704, e.g., from a first distribution. The first distribution may include, for instance, COP instances having a size range and/or node distribution range, which range and distribution may vary. The COP instances may each be associated with a solution (or solutions).

A first COP instance m=1 (step 806) is selected. The COP instance is input to the policy model 302 as an initial COP instance at 808, and the policy model processes the initial COP instance at 810, e.g., as set out in MDP flow method 400, to generate an output solution (e.g., trajectory) at 812. If the selected COP instance is the final COP instance (m=i) at 814, the neural policy parameters are updated, e.g., to optimize an objective, minimize a loss, etc., and stored at 816. Otherwise, the next COP instance in the distribution is selected at 818, and the training continues for that set/batch. It will be appreciated that processing the COP instances in the distribution (e.g., one or more datasets) can be done in parallel or in series, and updates, batch sizes, epochs, etc., may vary as will be understood by an artisan. Example training parameters are described with reference to experiments herein.

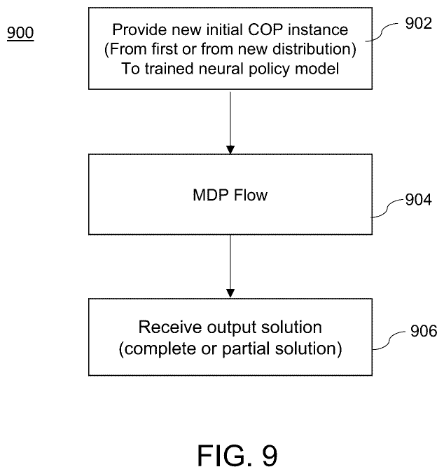

FIG. 9 shows an example inference (runtime) method for solving a COP using a trained neural policy model, e.g., neural policy model 302, 700 in a policy architecture such as architectures 200, 700. A new initial COP instance is provided at 902 to a trained neural policy model, e.g., trained as in training method 800 or as provided in other examples herein. The new initial COP instance at 902 may be from the same or a similar distribution (e.g., size, node distribution, etc.) as the distribution(s) used to train the neural policy model, or may be from a different distribution. For example, the new initial COP instance may have a significantly larger size than that of the COP instances in the distributions used for training.

The neural policy model processes, at 904, the provided new initial COP instance in a modeled Markov Decision Process, such as provided in the example MDP flow method in FIG. 4. The neural policy model generates one or more actions as an output solution, which is received at 906. The output solution can be or include a complete solution and/or a partial solution, e.g., a trajectory of one or more determined actions. The type of determined action will be based on the COP that is solved. Determined actions may be used for storage and/or for one or more downstream operations, such as but not limited to controlling an autonomous device.

Because of the quadratic complexity of self-attention, and because the example neural policy is called at each construction step, a total complexity of an example neural policy model 302, 700 for an instance of size N may be [symbol] (N³). Although other, transformer-based models such as TransformerTSP and the Attention Model may have a lower total complexity ( [symbol] (N²)), example policy models herein can provide better quality solutions faster than such baselines. This is in part because most neural models are called many times per instance in practice, typically for sampling from the learned policy or within a beam search. By contrast, a single rollout of an example policy according to examples herein can yield excellent results.

Given the complexity (NP-hardness) of targeted COPs, it can be useful to spend as much computation as possible at each time step, provided that the whole rollout is fast enough. However, it is also possible to address the quadratic attention bottleneck by using a linear attention model. For example, replacing a transformer-based model by a linear attention model such as the linear PerceiverIO, e.g., as disclosed in Jaegle et al., 2022, can significantly accelerate inference while still providing a competitive performance.

Example systems and methods herein need not assume a graph or structure on the COPs to define the example direct MDP or the example reduced MDP, yet these still provide methods for solving the COPs. Example systems and methods using supervised learning, e.g., imitation learning, to train a policy, can achieve strong performance without any search, removing the need for sophisticated search methods.

Example systems and methods also generalize to different COP instances distributions, such as larger instances and/or different node distributions, and boost generalization performance by accounting for symmetries in a given COP. Efficient MDPs can be provided with beneficial effects irrespective of the training method.

### Experiments

Experiments tested example policy training methods on TSP, CVRP, and KP. In experiments, the policy models for TSP and CVRP and baselines were trained on synthetic TSP and CVRP instances, respectively, of graph size 100, generated as in Kool et al., 2019. Graphs of size 100 were selected for training because this was the largest size for which (near) optimal solutions were still reasonably fast to obtain. The trained models were tested on synthetic instances of size 100, 200, 500, and 1,000 generated from the same distribution, as well as standard datasets (TSPLib, CVRPLib). During the experimental testing, the subgraphs were limited to the 250 nearest neighbors of the origin node, which reduced inference time while not significantly impacting the solution quality.

Hyperparameters and training: The same hyperparameters were used for all COPs. The example policy model had 9 layers, each built with 12 attention heads with an embedding size of 192 and dimension of the feedforward layer of 512. The model was trained by imitations of expert trajectories, using a cross-entropy loss. Solutions of the problems were obtained by using the Concorde solver for TSP and LKH heuristic for CVRP. A dataset of 1 million solutions was used. To sample trajectories out of this dataset, minibatches were formed by first sampling a number n between 4 and N (as path-TSP problems with less than 4 nodes are trivial), then sampling sub-paths of length n from the initial solution set. This was suitable since in the case of TSP, any sub-path of the optimal tour is also an optimal solution to the associated path-TSP sub-problem, and thus amenable to the path-TSP model.

At each epoch, a sub-path was sampled from each solution. By sampling subsequences among all possible infixes of the optimal solutions, an augmented dataset was automatically produced. A similar sampling strategy was used for CVRP and for KP.

Batches of size 1024 were formed, and the policy model was trained for 500 epochs, using ADAM (Kingma et al., Adam: A Method for Stochastic Optimization, In Proceedings of the 3rd International Conference on Learning Representations (ICLR), San Diego, 2015) as the optimizer with an initial learning rate of 7.5e−4 and decay of 0.98 every 50 epochs.

The example policy models were compared to the following methods: OR-Tools (Perron and Furnon, OR-tools, Google, 2022), LKH (K. Helsgaun, An Extension of the Lin-Kernighan-Helsgaun TSP Solver for Constrained Traveling Salesman and Vehicle Routing Problems. Technical report, Roskilde University, Roskilde, Denmark, 2017), and Hybrid Genetic Search (HGS) for the CVRP for non-neural methods; DIFUSCO+2opt and Att-GCN+MCTS as hybrid methods for TSP; and AM, TransformerTSP, MDAM, POMO, and DIMES as deep learning-based constructive methods. For all deep learning baselines, the corresponding model trained on graphs of size 100 and the best decoding strategy was used.

Four test datasets were generated with graphs of size 100, 200, 500, and 1000. For CVRP, capacities of 50, 80, 100, and 250, respectively, were used. Results for TSPLib instances with up to 4461 nodes and all CVRPLib instances with node coordinates in the Euclidean space were also considered. For all models, the optimality gap and the inference time were reported. The optimality gap for TSP was based on the optimal solutions obtained with Concorde. For CVRP, the LKH solutions were used as a reference to compute an optimality gap.

Example implementation may include platforms such as Python, C++, and others. Example hardware includes GPUs and CPUs. Implementation may also vary based on batch size, use of parallelization, etc. In the experiments, all deep learning models were run on a single Nvidia Tesla V100-S GPU with 24 GB memory, and other solvers on Intel™ Xeon™ CPU E5-2670 with 256 GB memory, in one thread.

### Results:

Table 1 summarizes results for TSP and CVRP. The bold values are the best optimality gaps (lower is better) and fastest inference time. The underlined cells represent the best compromise between the quality of the solution and the inference time. Results for models with * are taken from original papers from which these models are disclosed.

TABLE 1

| | | TSP 100 | | | TSP 200 | | | TSP 500 | | | TSP 1000 | | |
|---|---|---|---|---|---|---|---|---|---|---|---|---|---|
| | Concorde | 0.00% | 38 | m | 0.00% | 2 | m | 0.00% | 40 | m | 0.00% | 2.5 | h |
| | OR-Tools | 3.76% | 1.1 | h | 4.52% | 4 | m | 4.89% | 31 | m | 5.02% | 2.4 | h |
| | Att-GCN+MCTS* | 0.04% | 15 | m | 0.88% | 2 | m | 2.54% | 6 | m | 3.22% | 13 | m |
| | DIFUSCO G+2opt* | 0.24% | — | | — | — | | 2.40% | 4 | m | 3.40% | 12 | m |
| | AM bs1024 | 2.51% | 20 | m | 6.18% | 1 | m | 17.98% | 8 | m | 29.75% | 31 | m |
| | Trans TSP bs1024 | 0.46% | 51 | m | 5.12% | 1 | m | 36.14% | 9 | m | 76.21% | 37 | m |
| | MDAM bs50 | 0.39% | 45 | m | 2.04% | 3 | m | 9.88% | 13 | m | 19.96% | 1.1 | h |
| | POMO augx8 | 0.13% | 1 | m | 1.57% | 5 | s | 20.18% | 1 | m | 40.60% | 10 | m |
| | DIMES RL+S* | — | — | | — | — | | 16.07% | 1 | m | 17.69% | 2 | m |
| ours | BQ-Transformer G | 0.35% | 2 | m | 0.54% | 9 | s | 1.18% | 55 | s | 2.29% | 2 | m |
| | BQ-Transformer bs16 | 0.01% | 32 | m | 0.09% | 3 | m | 0.55% | 15 | m | 1.38% | 38 | m |
| | BQ-Perceiver G | 0.97% | 1 | m | 2.09% | 2 | s | 5.22% | 8 | s | 8.97% | 22 | s |
| | | CVRP 100 | | | CVRP 200 | | | CVRP 500 | | | CVRP 1000 | | |
| | LKH | 0.00% | 15.3 | h | 0.00% | 30 | m | 0.00% | 1.3 | h | 0.00% | 2.8 | h |
| | HGS | −0.51% | 15.3 | h | −1.02% | 30 | m | −1.25% | 1.3 | h | −1.10% | 2.8 | h |
| | OR-Tools | 9.62% | 1 | h | 10.70% | 3 | m | 11.40% | 18 | m | 13.56% | 43 | m |
| | AM bs1024 | 4.18% | 24 | m | 7.79% | 1 | m | 16.96% | 8 | m | 86.41% | 31 | m |
| | MDAM bs50 | 2.21% | 56 | m | 4.33% | 3 | m | 9.99% | 14 | m | 28.01% | 1.4 | h |
| | POMO augx8 | 0.69% | 1 | m | 4.77% | 5 | s | 20.57% | 1 | m | 141.06% | 10 | m |
| ours | BQ-Transformer G | 2.79% | 2 | m | 2.81% | 9 | s | 3.64% | 55 | s | 5.88% | 2 | m |
| | BQ-Transformer bs16 | 0.95% | 32 | m | 0.77% | 3 | m | 1.04% | 15 | m | 2.55% | 38 | m |
| | BQ-Perceiver G | 5.63% | 1 | m | 5.49% | 3 | s | 6.39% | 8 | s | 10.21% | 24 | s |

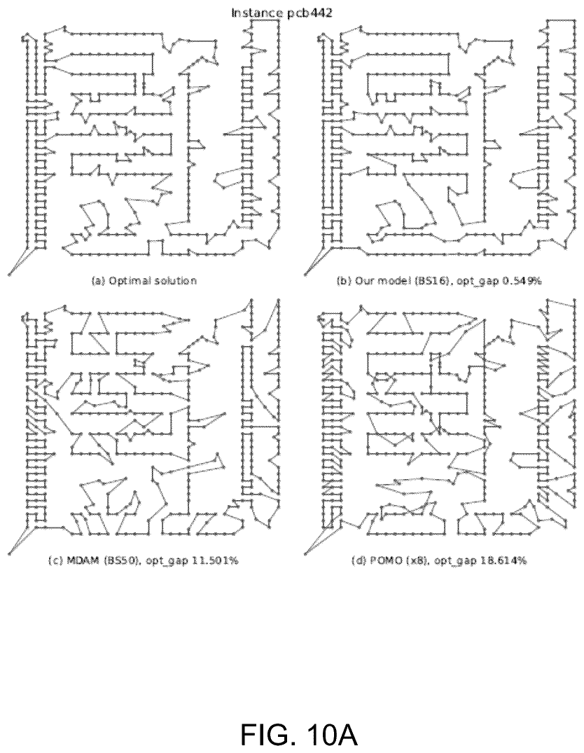

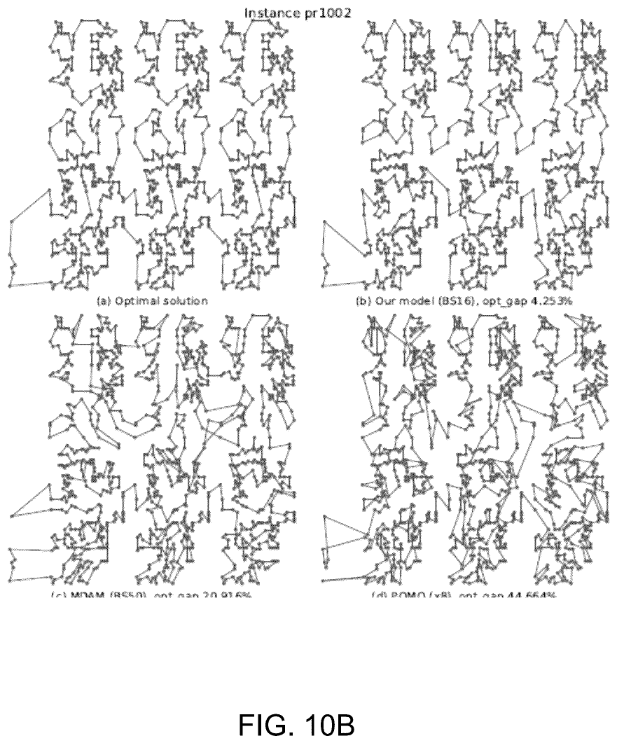

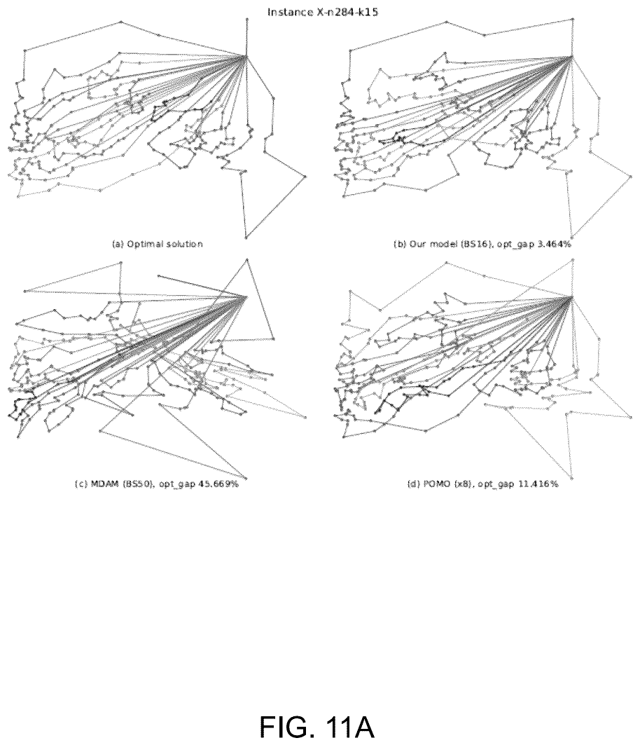

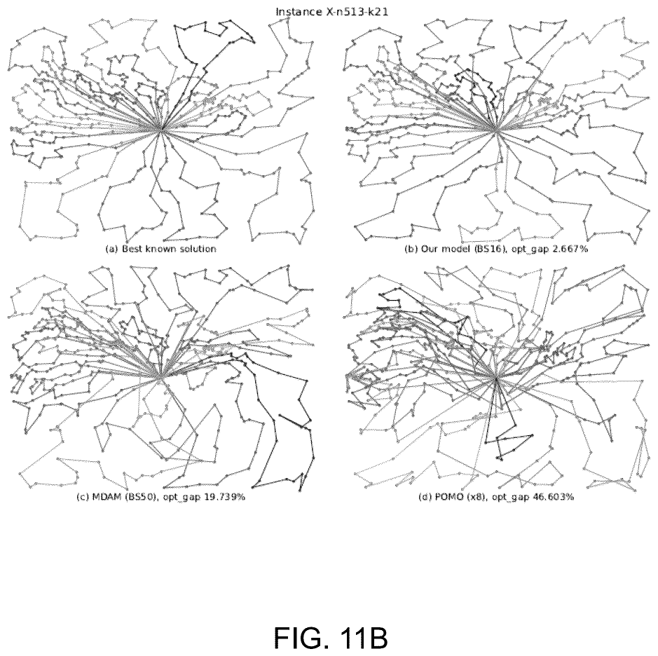

FIGS. 10A and 10B show example plots for TSPLib solutions for two respective instances, including an optimal solution, a solution generated by a model according to an example embodiment (BS16), and solutions generated by MDAM and POMO. FIGS. 11A and 11B show example plots for CVRPLib solutions for two respective instances, again including an optimal solution, a solution generated by a model according to an example embodiment (BS16), and solutions generated by MDAM and POMO.

For both COPs, experimental policy models according to example embodiments showed superior generalization on larger graphs, even with a greedy decoding strategy, which generates a single solution while all other baselines generated several baselines, and selected the best among them. For running time, with greedy decoding, example policy models were competitive with the POMO baseline, and significantly faster than other models.

Beam search further improved the optimality gap at the expense of computation time. Accelerated performance can be provided by replacing the quadratic attention blocks by the PerceiverIO architecture, which results in a considerable reduction of inference time for larger graphs, at the cost of some performance drop. Even with this trade-off, however, example policy models achieved excellent performance compared with other NCO baselines.

The example policy models outperformed baseline models in terms of generalization to larger instances in terms of optimality gap versus running time for TSP and CVPR. The more competitive models were hybrid models, which required an expensive search on top of the output of the neural network, and were 2 to 15 times slower, while being designed for TSP only.

In addition to the synthetic datasets, example policy models were tested on TSPLib and VRPLib instances of varying graph sizes, node distributions, demand distributions, and vehicle capacities. Table 2 shows that example policy models significantly outperformed the end-to-end baseline policies even with the greedy decoding strategy.

TABLE 2

| | MDAM | POMO | BQ (ours) | | | | MDAM | POMO | BQ (ours) | |
|---|---|---|---|---|---|---|---|---|---|---|
| Size | bs50 | x8 | greedy | bs16 | Set (size) | | bs50 | augx8 | greedy | bs16 |
| <100 | 3.06% | 0.42% | 0.34% | 0.06% | A | (32-80) | 6.17% | 4.86% | 4.52% | 1.18% |
| 100-200 | 5.14% | 2.31% | 1.99% | 1.21% | B | (30-77) | 8.77% | 5.13% | 6.36% | 2.48% |
| 200-500 | 11.32% | 13.32% | 2.23% | 0.92% | F | (44-134) | 16.96% | 15.49% | 6.63% | 5.94% |
| 500-1K | 20.40% | 31.58% | 2.61% | 1.91% | M | (100-200) | 5.92% | 4.99% | 3.58% | 2.66% |
| >1K | 40.81% | 62.61% | 6.42% | 5.90% | P | (15-100) | 8.44% | 14.69% | 3.61% | 1.54% |
| All | 19.01% | 26.30% | 3.30% | 2.55% | X | (100-1K) | 34.17% | 21.62% | 9.94% | 7.22% |
| | | | | | All | (15-1K) | 22.36% | 15.58% | 7.62% | 4.83% |

The experiments showed that the example policy models based on reduced MDPs result in a significantly reduced state space while its optimal policies still can exactly solve the original COP. The example policy network incorporating a transformer-based architecture was shown to generalize particularly well for the example combinatorial optimization problems (COPs) TSP, CVRP, and KP, and significantly outperformed not only similar end-to-end neural-based constructive solvers but also hybrid methods that combine learning with search. Though imitation learning was used to train experimental policy networks, example reduced MDP and associated policy models can also be trained with reinforcement learning.

Experimental results for KP: A training dataset was generated as disclosed in Kwon et al., POMO: Policy Optimization with Multiple Optima for Reinforcement Learning, In Advances in Neural Information Processing Systems, volume 33, pages 21188-21198, 2020. An example policy model was trained on 1M KP instances of size 200 and capacity 25, with values and weights randomly sampled from the unit interval. The dynamic programming algorithm from ORTools was used to compute ground-truth optimal solutions. The hyperparameters used were the same as for the experimental TSP model described herein, except that the training was shorter (as it converged in 50 epochs).

The example policy model was evaluated on test datasets with 200, 500, and 1000 items and capacities of 10, 25, 50, and 100, for each problem size. Table 3, below, shows the performance of the experimental KP model compared to POMO (one of the best performing NCO models on KP). The example KP model achieved better overall performance and significantly better performance on the out-of-distribution datasets (datasets of size 1000 and datasets with a capacity of 10). Even though the example KP model generates a single solution per instance, as opposed to POMO, which builds N solutions per instance and selects the best one, the example KP model achieved better overall results.

TABLE 3

| | | Optimal | POMO (single traj.) | | POMO (all traj.) | | BQ ours (greedy) | |
|---|---|---|---|---|---|---|---|---|
| | | value | value | optgap | value | optgap | value | optgap |
| N = 200 | C = 10 | 36.073 | 34.062 | 5.565% | 34.961 | 3.076% | 35.961 | 0.311% |
| | C = 25 | 57.429 | 57.143 | 0.499% | 57.420 | 0.016% | 57.371 | 0.102% |
| | C = 50 | 81.100 | 79.766 | 1.617% | 80.085 | 1.229% | 80.564 | 0.668% |
| | C = 100 | 99.773 | 99.416 | 0.358% | 99.483 | 0.291% | 99.694 | 0.080% |
| N = 500 | C = 10 | 57.456 | 51.829 | 9.769% | 54.213 | 5.627% | 56.853 | 1.054% |
| | C = 25 | 91.026 | 85.186 | 6.414% | 86.482 | 4.992% | 90.741 | 0.314% |
| | C = 50 | 128.999 | 128.646 | 0.273% | 128.946 | 0.042% | 128.906 | 0.072% |
| | C = 100 | 182.395 | 181.615 | 0.424% | 181.870 | 0.285% | 181.654 | 0.407% |
| N = 1000 | C = 10 | 81.334 | 53.319 | 34.401% | 58.072 | 28.565% | 79.650 | 2.074% |
| | C = 25 | 128.993 | 122.112 | 5.340% | 123.775 | 4.046% | 128.240 | 0.584% |
| | C = 50 | 182.813 | 170.223 | 6.877% | 171.789 | 6.021% | 181.985 | 0.451% |
| | C = 100 | 257.411 | 252.701 | 1.831% | 253.361 | 1.575% | 257.224 | 0.072% |

| | | | | |
|---|---|---|---|---|
| All | — | 6.131% | 4.647% | 0.516% |

Inference time of example models can be reduced by using a k-nearest neighbor heuristic to reduce the search space. For both greedy rollouts and beam search strategies, at every step, it is possible to reduce the remaining graph by considering only a certain number of neighboring nodes. Such an approach can reduce execution time, and in some instances can improve performance (reduce the optimality gap). The criteria on which to select the nearest neighbors can be the distance or can be another metric as some greedy heuristic for the problem. For example, for the Knapsack Problem, the items could be restricted to the k items with highest values, or highest ratios of value/weight, etc.

### Other Embodiments

PerceiverIO Architecture: To construct a solution, an example policy model performs N steps, and computes N² attention matrices at each step, resulting in a total complexity of [symbol] (N³). Providing a compromise between model complexity and quality of the solution may be useful, for instance, when applying example models to large graph sizes.

In some example embodiments, the complexity of attention can be reduced by replacing the transformer model in the model architecture with an architecture such as the PerceiverIO Architecture. PerceiverIO computes cross-attention between input data and latent variables and then computes self-attention between the latent variables, resulting in all computations being performed in the latent space. This approach allows the number of operations to be linear (instead of, say, quadratic) in the input's length.

In a nonlimiting example policy model with PerceiverIO Architecture, similar hyperparameters can be used as with an example transformer model (e.g., 9 attention layers with 8 heads, an embedding size of 192, and a feed-forward layer dimension of 512). For the latent space, a vector with dimensions of 64×48 is used. It will be appreciated that other suitable hyperparameters may be used, which may be determined, e.g., using known testing or evaluating methods. The output query array can be the same as the input array.

Approximated model: An example model architecture for a reduced MDP calls the entire model after each construction step, which effectively recomputes the embeddings at each state. It is also possible to implement an approximated version of the model to reduce inference time at the possible expense of performance by, for example, fixing the bottom layers (or some of the bottom layers) and recomputing only the top layer (or one or more top layers), by masking already visited nodes, and adding the updated information (origin and destination tokens for TSP).

Dataset generation using expert trajectories: Example datasets include (or consist of) pairs of a problem instance and a solution. For imitation learning, the problem instances can be paired with an expert trajectory in the MDP. However, multiple trajectories may be obtained from the solution.

For example, in the TSP, a solution is a loop in a graph, and one needs to decide at which node its construction started and in which direction it proceeded. In the CVRP, the order in which the subtours are constructed needs also to be decided. Accordingly, example datasets may be pre-processed to transform solutions into corresponding construction trajectories (a choice for each or even all possible ones).

Such a transformation can have a significant effect on performance. In the CVRP, for instance, performance can be improved by training the policy model on expert solutions that sort subtours by the remaining vehicle capacity at the end of each subtour. The last subtour in the expert trajectory has the largest remaining capacity (the subtour that visits remaining unvisited nodes), while the first subtour had the smallest remaining capacity (usually 0). This data preprocessing step can improve performance significantly compared to, say, training on expert trajectories with subtours in arbitrary order. Without wishing to limit the scope of the disclosure, it is believed that such trajectories encourage the model to create subtours that use the whole vehicle capacity whenever possible.

### Multi-Agent Task Assignment

Additional features of direct and reduced MDPs for solving MATAPs according to example systems and methods will now be described.

Solution space: As referred to herein, a plan is an assignment of a (possibly empty or singleton) finite sequence of tasks to each of a set of agents, which plan satisfies an order consistency condition in that the union of the immediate precedence relations on tasks induced by these sequences forms a directed acyclic graph. The set of plans can be denoted as the set of partial solutions X.

Generally, the order consistency condition ensures that a plan is realizable, that is, there exists a schedule such that all the visits to a task occur simultaneously and that the visits by an agent happen in the order of the plan. For example, a plan where agent a visits tasks 1, 2 (in that order) and agent b visits tasks 2, 1 is not realizable since, if all the visits to task 1 (resp. 2) are scheduled at the same time, then the order of visits by a requires t₁<t₂ and the order of visits by b requires t₂<t₁, providing a contradiction. Cycles can be of arbitrary length, as in, e.g., {a: 123, b: 345, c: 561}.

Formally, agents and tasks are indexed in [symbol] , and a plan is a pair of binary tensors x∈2 [symbol] ^{×} [symbol] ^{×} [symbol] and x̅∈2 [symbol] ^{×} [symbol] with finite support, where xₐᵤᵥ indicates whether agent a visits task u immediately before task v in the plan, and x̅ₐᵤ indicates whether agent a visits task u in the plan. Tensor x̅ can essentially be derived from x, except that x alone cannot distinguish between empty and singleton visits, so both x, x̅ are needed. To simplify notations, in the description below x can refer to the pair x, x̅. Binary tensors x, x̅ form a plan if and only if they satisfy the following structural feasibility constraints:

$$\begin{matrix}∀ a & \sum \text{?} \vert \sum \text{?} ( x \text{?} - x \text{?} ) \vert \leq 2 \\ ∀ \text{?} \geq 1 , u \text{?} & u \text{?} = u \text{?} ⇒ \prod \text{?} max \text{?} = 0 \\ ∀ \text{?} u , \text{?} & x \text{?} \leq min ( \text{?} , \text{?} ) \sum \text{?} \leq 1 + \sum \text{?} \sum \text{?} < ∞\end{matrix}$$

$$\text{?} \text{indicates text missing or illegible when filed}$$

Additionally, [symbol] , [symbol] denotes binary tensors in 2 [symbol] ^{×} [symbol] , derived from x,x̅, where [symbol] (resp. [symbol] ) indicates whether task u is the first (resp. last) task visited by agent a in x:

$$\begin{matrix}{x}_{au}^{⊲} = \text{?} {\overline{x}}_{au} ( 1 - max \text{?} x \text{?} ) & {x}_{au}^{⊳}\end{matrix} = \text{?} {\ddot{x}}_{au} ( 1 - max \text{?} x \text{?} )$$

$$\text{?} \text{indicates text missing or illegible when filed}$$

Finally, given finite sets A, T of agents and tasks, respectively, plan x is said to be of sort [symbol] A, T [symbol] if its visits involve only agents in A and tasks in T. The smallest (for inclusion) sort of x is denoted |x|, in which

$$\vert x \vert = ( \{ a \vert ∃ u {\overline{x}}_{au} = 1 \} , \{ u \vert ∃ a {\overline{x}}_{au} = 1 \} )$$

Plan concatenation: Concatenation is a partial operation on plans. If x, x′ are plans, their concatenation y=x·x′ can be obtained by chaining, for each agent, the sequences of its visits in x and in x′. The result may not be a plan, as the order consistency condition may be violated, hence it defines a partial operation. Formally, y is defined as follows, letting |x|= [symbol] A, T [symbol] and |x′|= [symbol] A′, T′ [symbol] :

If x, x′ visit no task in common, i.e., T∩T′=Ø, then y is the plan

$${\overline{y}}_{au} {=}_{def} 𝕀 [ u ∈ T ] {\overline{x}}_{au} + 𝕀 [ u ∈ {T}^{′} ] {\overline{x}}_{au}^{′}$$

$${y}_{auv} {=}_{def} 𝕀 [ u , v ∈ T ] {x}_{auv} + 𝕀 [ u , v ∈ {T}^{′} ] {x}_{auv}^{′} + 𝕀 [ u ∈ T , v ∈ {T}^{′} ] {x}_{au}^{⊲} {x}_{av}^{′ ⊲}$$

Otherwise (when T{∩}T′≠Ø) the concatenation is undefined: y=⊥.

This partial operation can be straightforwardly extended into an operation on [symbol] ∪{⊥} by adding the clause x·x′=⊥ whenever x=⊥ or x′=⊥. It can be shown that ( [symbol] ∪{⊥}, 0, ·) forms a monoid (i.e., the operation is associative and has a neutral element, the empty plan 0). It is non-commutative, i.e., y=x·x′ and y′=x′·x may not be identical. If x=⊥ or x′=⊥ or T{∩}T′≠Ø, then, by definition, y=y′=⊥. But in all the other cases, y=y′ exists if and only if A∩A′=Ø, i.e., when x, x′ do not involve the same agents (in addition to not involving the same tasks).

Stepwise construction: A step is a plan in which exactly one task is visited by some agents. The set of steps is denoted [symbol] . Hence a plan z is a step iff |z|= [symbol] |, {t} [symbol] where I is some non-empty set of agents and t is a task, called the task assigned by z. If z∈ [symbol] , then zₐᵤᵥ=0 for all agents a and tasks u, v, and z̅ₐ̅ᵤ̅=z̅ₐ̅ᵤ̅=[a∈I, u=t]. Hence a step z can be entirely characterized by |z|. Mapping ξ from sequences of steps to plans (or ⊥) is defined by:

$$ξ ( {z}_{1 : n} ) {=}_{def} {z}_{1} \text{?} {z}_{n}$$

$$\text{?} \text{indicates text missing or illegible when filed}$$

This expression is well defined, even when n=0, in the monoid ( [symbol] ∪{⊥}, ·, 0). ξ(z_{1:n})≠⊥ if and only if the sequence of tasks assigned by z_{1:n} are pairwise distinct. For a given plan x, the set of sequences z_{1:n} such that ξ(z_{1:n})=x is both non-empty and finite, i.e., ( [symbol] , ·, 0, ⊥, [symbol] ) forms a solution space. Thus, for any plan x∈ [symbol] , there exists at least one sequence of steps z_{1:n} such that x=(z_{1:n}).

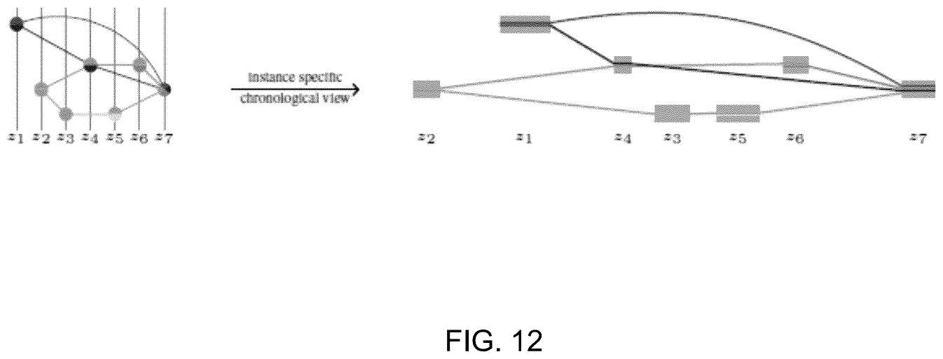

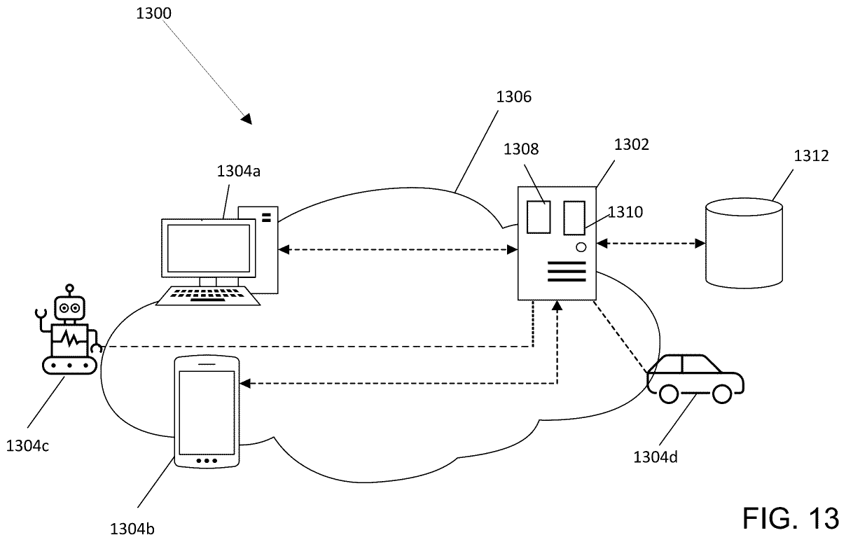

A diagrammatic illustration of such a construction is given in FIG. 12, left, showing a plan as a sequence of steps, where each task involved in x is a circular blob and each agent involved in x corresponds to a colour or shade, present in the blob of each task it visits. The left-right order of the tasks is that of the assigning steps in sequence z_{1:n}, and each edge on the paths is also oriented from left to right, so the order consistency condition is always ensured. FIG. 12, right, shows the chronological view of that plan in a MATAP instance.

The (constant) horizontal interval between tasks, their (constant) size and their vertical positions are all meaningless. In the example, the step sequence z₂₁₃₄₆₅₇ maps to the exact same plan, although the diagram looks slightly different: the ordering of steps 12 (or of steps 56) is irrelevant, since they do not involve the same agents. On the other hand, sequence z₁₃₂₄₅₆₇ maps to a different plan: the ordering of steps 23 is meaningful, since they both involve the green agent.

A Multi Agent Task Assignment Problem (MATAP) instance, an example COP instance, can be parametrized by [symbol] A, T, δ, δ*, γ, γ*, μ, [symbol] including:
Dimension parameters (sort): [symbol] A, T [symbol] where A, T are the finite sets of agents and tasks, respectively;
Duration parameters: tensors δ∈ [symbol] ₊^{A×T×T} and δ*∈ [symbol] ₊^{T}, where δₐᵤᵥ is the duration for agent a to switch from task u to task v and δᵤ* is the processing duration of task u;
Date parameters: tensors γ∈ [symbol] ^{A×T} and γ*∈ [symbol] ^{T}, where γₐᵤ is the date at which agent a can be ready for task u and γᵤ* is the due date of task u;
Feasibility constraint: mapping μ∈2 [symbol] which is both satisfiable, i.e., ∃x μ(x)=1, and sort-compliant, i.e. if μ(x)=1 then |x|= [symbol] A_{·}, T [symbol] for some A_{·}⊂A (which is stronger than merely x being of sort [symbol] A, T [symbol] ). μ is extended with μ(⊥)=0.

All of these parameters can be at most of quadratic size in the number of tasks, except the feasibility constraint μ, which is of finite but exponential size (finite because of the sort-compliance requirement and the finiteness of A and T). A further parametrization of μ is provided herein to reduce its complexity.

Feasibility and objective: A complete solution to an example MATAP problem instance can be incorporated in a schedule giving, for each task, its start and end date as well as the agents participating in its execution, consistent with the parameters. Although schedules form a continuous space, the objective to optimize is a piecewise linear function of the schedule, based only on its underlying plan, which does not specify dates but only the sequence of tasks visited by each agent. Given a plan, one can find the optimal feasible schedule corresponding to that plan. Hence, the discrete solution space [symbol] of plans provides an appropriate choice for the MATAP problem.

Formally, given parameters [symbol] A, T, δ, δ*, γ, γ*, μ [symbol] , one can define the corresponding MATAP instance (ƒ, X)∈ [symbol] [symbol] , where X⊂ [symbol] is the feasible set and ƒ∈ [symbol] [symbol] is the objective mapping.

The feasible set X can be given by

X=dei{x∈ [symbol] |p(x)=1}

By definition, is satisfiable, so [symbol] ≠Ø, and sort-compliant, hence all feasible solutions are of sort [symbol] A, T [symbol] , i.e., involve only visits of tasks in T by agents in A, and must furthermore satisfy that every task in T is visited by at least one agent in A. This implies that X is finite, since both A and T are finite. Thus X is finite and non-empty, as required for (ƒ, X) to be in [symbol] [symbol] .

The objective mapping ƒ can be defined by first defining the chronological interpretation of a plan x, that is, the optimal schedule corresponding to that plan, captured by two tensors, always defined but meaningful only when x is of sort [symbol] A, T [symbol] :
a tensor Γ*(x)∈ [symbol] ^{T} where Γ*(x)ᵤ is the earliest completion date of task u in the executions of plan x (if no agent visits u in x, the value is −∞).
a tensor Γ(x)∈ [symbol] ^{A×T} where Γ(x)ₐᵥ is the earliest date at which agent a visits task v in the executions of plan x (when a does not visit v in x, the value is unused and can be arbitrary);
Formally, they may be defined by the following cross-induction:

$$\begin{matrix}∀ a ∈ T & {{Γ}^{*} ( x )}_{u} {=}_{def} {δ}_{u}^{*} + max \{ {Γ ( x )}_{au} \vert a ∈ A , {\overline{x}}_{au} = 1 \} with max θ = - ∞ \\ ∀ a ∈ & {Γ ( x )}_{av} {=}_{def} \underline{{x}_{av}^{⊲}} {γ}_{av} + {\sum }_{u ∈ {T}^{\underline{{x}_{auv}}}} ( {{Γ}^{*} ( x )}_{u} + {δ}_{auv} ) )\end{matrix}$$

The order consistency condition on plans ensures this induction is always correct (not an infinite loop). Note that in the latter equation above, the underlined terms act as exclusive binary selectors, whether v is visited by a immediately after some task u (case xₐᵤᵥ, =1) or v is the first task visited by a (case [symbol] =1). When a does not visit v at all, Γ(x)ₐᵥ=0 but this is unused and meaningless. The objective can now be defined the objective to minimize:

$$f ( x ) {=}_{def} {\sum }_{u ∈ T} max ( {{Γ}^{*} ( x )}_{u} - {γ}_{u}^{*} , 0 )$$

In other words, the cumulated excess completion time beyond the due date for each task. Note that, in the above minimization, the tasks u∈T not visited by x do not contribute to the objective at all, since Γ*(x)ᵤ=−∞. This may be suboptimal, and other formulations of ƒ are possible, based on a more accurate estimate of the contribution of unvisited tasks in the final objective. They do not change the value at the feasible solutions, where, by sort-compliance of μ, all the tasks in T are visited.

Chronological view: Given a problem instance and a plan x of sort [symbol] A, T [symbol] , obtained by a construction ξ(z_{1:n}) (FIG. 12, left), an illustration of the chronological interpretation of plan x in the given instance is obtained by distorting the plan diagram in various ways, preserving the orientation of the edges (FIG. 12, right). The step ordering in the chronological view (sequence z₂₁₄₃₅₆₇ in the example) may be different from that of the plan construction but it still maps to the same plan. By design, the horizontal position of the steps in the chronological view is meaningful: a step assigning a task u starts exactly at date Γ*(x)ᵤ.

Instance normalization: The tensors defined in the objective mapping above depend on the choice of time unit to measure durations as well as the choice of time origin from which to measure dates, used in the parameters defining the instances. However, the optimal plans for a given instance are independent of these choices. Let (ƒ, X) be an instance and (ƒ′, X′) obtained from the same parameters as (ƒ, X) where time is shifted and dilated, i.e., for some constants c (time shift) and d>0 (time dilation) there exists:

$$\begin{matrix}{δ}^{′} = d {δ}^{′} = d {δ}^{*} {γ}^{′} = d γ + c {γ}^{′ *} = d {γ}^{*} + c {μ}^{′} = μ \\ Hence , {X}^{′} = X {Γ}^{′} ( x ) = d Γ ( x ) + c {Γ}^{′ *} ( x ) = d {Γ}^{*} ( x ) + c {f}^{′} = df\end{matrix}$$

Therefore,

$$arg {min}_{x ∈ {X}^{′}} {f}^{′} ( x ) = arg {min}_{x ∈ X} f ( x ) ,$$

so (ƒ, X) and (ƒ′, X′) should be indistinguishable. One way to achieve this is by normalizing problem instances so that if two problem instances can be obtained from one another by time shift and dilation, they have the same normal form. A possible choice of normalization is given by imposing the constraint:

Σᵤ [symbol] ᵤ [symbol] =0Πᵤδᵤ [symbol] =1
obtained by setting

$$d = ( {\prod }_{u} {δ}_{u}^{*} ) \text{?} c = - \frac{d}{T} {\sum }_{u} {γ}_{u}^{*}$$

$$\text{?} \text{indicates text missing or illegible when filed}$$

Tail recursion in MATAP: Let (ƒ, X) be a MATAP instance parametrized by [symbol] A, T, δ, δ*, γ, γ*, μ [symbol] , and x∈X̅ a plan. By definition,

Φ_{(ƒ,X)}(x)=(ƒ′,X′) where ƒ′=ƒ*x and X′=X*x

Let |x|=(A_{·}, T_{·}). Since x∈X̅, it must be of sort (A, T), hence A_{·}⊂A and T_{·}⊂T. Then the tail instance (ƒ′, X′) is a MATAP instance parametrized by (A′, T′, δ′, δ′*, γ′, γ′*, μ′) where

$$( {A}^{′} , {T}^{′} ) {=}_{def} ( A , T \backslash {T}_{o} )$$

$${{δ}^{*} , {δ}^{′ *} , {γ}^{*} {=}_{def} δ {\vert}_{A \times {T}^{*} \times {T}^{u}} , {δ}^{*} {\vert}_{{T}^{*}} , {γ}^{*} \vert}_{{T}^{′}}$$

$$\begin{matrix}∀ a ∈ A , v ∈ {T}^{′} & {γ}_{av}^{′}\end{matrix} {=}_{def} \underline{𝕀 [ a ∉ {A}_{o} ]} {γ}_{av} + {\sum }_{u ∈ {T}_{*}} \underline{{x}_{au}^{⊲}} ( {{T}^{*} ( x )}_{u} + {δ}_{auv} )$$

$$∀ {x}^{′} ∈ χ \qquad {μ}^{′} ( {x}^{′} ) {=}_{def} μ ( x ∘ {x}^{′} )$$

It can be shown that μ′ is both satisfiable (since x∈X̅) and sort-compliant for (A′, T′), as required. The equations can be justified as follows: to be ready for a task v not visited by x yet, agent a must first complete all the tasks on its path in x then switch to v. The underlined terms act as exclusive binary selectors, whether some task u is the last task visited by a in x (case [symbol] =1) or a is not involved at all in x (case a/∈A_{·}). The latter equations above could also be written more simply as μ′=μ*x. Overall, the above equations show that MATAP is tail recursive.

Controlling the complexity of the feasibility constraint: As observed above, the feasibility constraint parameter of a MATAP instance is of exponential size in the number of tasks. To address this problem, subproblems of MATAP may be considered, which are defined by restrictions on μ, with the requirement that they must preserve the tail recursion property satisfied by unrestricted MATAP.

In many MATAP applications, two kinds of feasibility constraints are imposed: skill and precedence. Consider a problem instance of sort (A, T).
Skill constraints control for each task u∈T the family (x̅ₐ̅ᵤ̅)_{a∈A} in 2^{A} denoted x̅_̅{̅A̅u̅}̅, i.e., the crew of agents in A which visit task u.
Precedence constraints control for each pair of (distinct) tasks u, v∈T the family x_{Auv}, i.e., the agents in A which visit task u then task v consecutively.

Let MATAPₛₚ be the subproblem of MATAP where the feasibility constraint combines skill and precedence constraints only. Formally, in a MATAPₛₚ instance, the feasibility constraint factorizes as

μ(x)=Π_{u∈T}μ [symbol] (skill)(\ddot{x}_{Au})Π_{u,v∈T}μ [symbol] ^{(prec)}( [symbol] A

[symbol]

where μ^{(skill)}∈2^{T×2}^{^{A}} and μ^{(prec)}∈2^{T×T×2}^{^{A}} Thus, the size of the feasibility constraint becomes quadratic in the number of tasks. It is still exponential in the number of agents, a limitation which is addressed below.

Skill-only feasibility constraints: First consider the simpler subproblem MATAPₛ of MATAPₛₚ with no precedence constraints, i.e., where μ^{(prec)}=1. In the definition of Φ provided above, when (ƒ, X) is in MATAP_{S} and x∈X̅, the feasibility constraint in (ƒ′, X′) factorizes as

μ′(x′)=μ(x·x′)=Π_{u∈T} [symbol] μ [symbol] ^{(skill)}(\ddot{x}A [symbol] )Π_{v∈} [symbol] ₓ [symbol] μ [symbol] ^{(skill)}(\ddot{x} [symbol] _{Av}′)

The underlined term C is independent of x′. If C=0 held, μ′ could not be satisfiable, which contradicts x∈X̅, and thus C=1. The residual feasibility constraint involves skill constraints only, hence (ƒ′, X′) is in MATAP_{S} with

Mixed skill-precedence feasibility constraints: With a full MATAPₛₚ instance, the situation is more complex. The feasibility constraint in (ƒ′, X′) factorises as

$${μ}^{′} ( {x}^{′} ) = μ ( x ∘ {x}^{′} ) = \underline{{\prod }_{} \text{?} {μ}_{u}^{( skill )} ( {\overline{x}}_{Au} ) {\prod }_{} \text{?} {μ}_{uv}^{( prec )} ( {x}_{Auv} ) {\prod }_{} \text{?} μ \text{?} ( {0}_{Au} )} {\prod }_{} \text{?} {μ}_{v}^{( skill )} ( {\overline{x}}_{Ar}^{′} ) {\prod }_{} \text{?} {μ}_{uv}^{( prec )} ( {x}_{Auv}^{′} ) {\prod }_{} \text{?} μ \text{?} \text{?}$$

$$\text{?} \text{indicates text missing or illegible when filed}$$

Again, the underlined term C is independent of x′, and cannot be null since x∈X̅, and thus C=1. The residual feasibility constraint thus obtained is not of the [symbol] factorised form above, because of the factor involving [symbol] , i.e., (ƒ′, X′) is not a MATAPₛₚ instance, and MATAPₛₚ is not tail recursive. However, (ƒ′, X′) belongs to a broader subproblem MATAPₛₛₚ of MATAP, defined by a richer factorization than provided above for the feasibility constraint, with the bracket portion corresponding to the factorization above:

$$μ ( x ) = {\prod }_{u ∈ T} {μ}_{v}^{( start )} ( {x}_{Av}^{⊲} ) \underbrace{{\prod }_{u ∈ T} {μ}_{v}^{( skill )} ( {\overline{x}}_{Au} ) {\prod }_{uv ∈ T} {μ}_{uv}^{( prec )} ( {x}_{Auv} )}$$

where μ^{(start)}∈2^{T×2}^{^{A}} controls for each task in T the set of agents in A which visit that task first, before any other. This adds two new factors in the decomposition of μ′ given by the above factorization, of which one is independent of x′ and included in C:

Π_{v∈T}_{_{·}}μᵤ^{(start)}( [symbol] )_{C},Π_{v∈T},μᵥ^{(start)}(1_{A\A}_{ₒ} [symbol] )

It is apparent that a MATAPₛₚ instance is a MATAPₛₛₚ instance where μ^{(start)}=1, hence MATAPₛₚ is a subproblem of MATAPₛₛₚ. Now, in the definition of Φ above, when (ƒ, X) is in MATAPₛₛₚ, then so is (ƒ′, X′), with its parameters being obtained from those of (ƒ, X) as provided above, except that the latter equation is replaced by

$${μ}^{′ ( skill )} , {μ}^{′ ( prec )} {=}_{def} {μ}^{( skill )} {↾}_{{T}^{′}} , {μ}^{( prec )} {↾}_{{T}^{′} \times {T}^{′}}$$

$$∀ v ∈ {T}^{′} , q ∈ {2}^{A}$$

$${μ}_{v}^{′ ( start )} ( q ) {=}_{def} {μ}_{v}^{( start )} ( q {1}_{A \backslash {A}_{o}} ) {\prod }_{u ∈ {T}_{o}} {μ}_{uv}^{( prec )} ( {qx}_{Au}^{⊲} )$$

MATAPₛₛₚ is tail recursive.

The reduced MDP in MATAPₛₛₚ: In the reduced MDP, if (ƒ, X) is a MATAPₛₛₚ instance of sort [symbol] A, T [symbol] and z is a step with |z|= [symbol] |, {t} [symbol] , applying z to (ƒ, X) yields (ƒ′, X′)=Φ_{(ƒ,X)}(z), conditioned on X′≠Ø, or equivalently, z∈X̅. Under that condition, (ƒ′, X′) is a MATAPₛₛₚ instance of sort [symbol] A, T′ [symbol] where T′=T\{t}, resulting in:

∀a∈A,v∈T′

$${γ}_{av}^{′} {=}_{def} 𝕀 [ a ∉ I ] {γ}_{av} + 𝕀 [ a ∈ I ] ( \overline{γ} + {δ}_{atv} ) where \overline{γ} = {max}_{a ∈ I γ at} + {δ}_{t}^{*}$$

$$∀ v ∈ {T}^{′} , q ∈ {2}^{A}$$

$${μ}_{v}^{′ ( start )} ( q ) {=}_{def} {μ}_{v}^{( start )} ( q {1}_{A \backslash I} ) {μ}_{uv}^{( prec )} ( q {1}_{I} )$$

The transition is conditioned on z∈X̅ which holds iff: [C] z is of sort [symbol] A, T [symbol] and C=1, and [SAT] μ′ is satisfiable, i.e.

[C]t∈T,I⊂A

μₜ^{(skill)}(1_{I})=μₜ^{(start)}(1_{I})=1

∀v∈T′μᵥₜ^{(prec)}(0_{A})=1

[SAT]∃x′μ′(x′)=1

The reward of the transition is given by max(γ̅−γₜ*, 0) where γ̅ is defined as shown above. This assumes no normalization (as also defined above) is applied, otherwise the reward should be corrected with the accumulated time dilation used in the normalizations (additional information to include and maintain in the instances).

The MATAPₛₛₚ* subproblem: In MATAPₛₛₚ, the size of the feasibility constraint is quadratic in the number of tasks but still exponential in the number of agents. This last hurdle can be addressed by considering the subproblem MATAPₛₛₚ* of MATAPₛₛₚ where the components of the feasiblity constraint are further parametrised by a set S of skills which forms a partition of the set A of agents (each agent has exactly one skill), and for all u, v∈T, q∈2^{A}

μₐ^{(skill)}(q)=defΠ_{s∈S} [symbol] [qₛ=λₛᵤ^{(skill)}]

μᵤᵥ^{(prec)}(q)=defΠ_{s∈S} [symbol] [qₛ≥λₛᵤᵥ^{(prec)}]

μᵥ^{(start)}(q)=defΠ_{u∈A} [symbol] [qₐ≥λₐᵥ^{(start)}]

where for all s∈S, qₛ=_{def} Σ_{a∈s}qₐ, and λ^{(skill)}∈2^{S×T}, λ^{(prec)}∈2^{S×T×T}, λ^{(start)}∈2^{A×T} are parameters. They can be interpreted as follows.
Parameter λₛᵤ^{(skill)} indicates whether task u requires skill s: if it does (resp. does not), then, for a plan to be feasible, task u must be visited by exactly one (resp. no) agent of skill s.
Parameter λₛᵤᵥ^{(prec)} indicates, when set, that at least one agent of skill s must visit tasks u then v consecutively.
Parameter λₐᵤ^{(start)} indicates, when set, that agent a must visit task u before any other task.

With this restriction, the size of the feasibility constraint becomes linear in the number of agents. If (ƒ, X) is a MATAPₛₛₚ* instance with parameter λ, then the outcome (ƒ′, X′) of a successful transition from (ƒ, X) in the adjoint MDP set out above is also a MATAPₛₛₚ* instance with parameter λ′, resulting in:

$${λ}^{′ ( skill )} , {λ}^{′ ( prec )} {=}_{def} {λ}^{( skill )} {↾}_{S \times T} , {λ}^{( prec )} {↾}_{S \times {T}^{′} \times {T}^{′}}$$

$$∀ s ∈ S , a ∈ s , v ∈ {T}^{′}$$

$${λ}_{av}^{′ ( start )} {=}_{def} 𝕀 [ a ∉ I ] {λ}_{av}^{( start )} + 𝕀 [ a ∈ I ] {λ}_{stv}^{( prec )}$$

As a corollary, MATAPₛₛₚ* is tail recursive. The transition is conditioned on z∈X̅ given by the equation above which becomes

$$[ C ] t ∈ T , I ⊂ A \{ \begin{matrix}∀ s ∈ S {λ}_{st}^{( skill )} = \vert I ⋂ s \vert \\ ∀ a ∈ A \backslash I {λ}_{at}^{( start )} = 0\end{matrix}$$

$$∀ v ∈ {T}^{′} \{ \begin{matrix}∀ s ∈ S {λ}_{svt}^{( prec )} = 0 \\ ∀ s ∈ I {λ}_{av}^{( start )} = 0\end{matrix}$$

Thus, in MATAPₛₛₚ*, all these conditions are linear in the number of tasks and agents. In particular, the condition [SAT] above vanishes, removing the costly check that μ′ is satisfiable at each transition of the MDP.

### System Architecture

Example systems, methods, and embodiments may be implemented within an architecture 1300 such as the architecture illustrated in FIG. 13, which comprises a server 1302 and one or more client devices 1304a, 1304b, 1304c, 1304d that communicate over a network 1306 which may be wireless and/or wired, such as the Internet, for data exchange. The server 1302 and the client devices 1304a, 1304b, 1304c, 1304d can each include a processor, e.g., processor 1308 and a memory, e.g., memory 1310 (shown by example in server 1302, but may also be in client devices 1304), such as but not limited to random-access memory (RAM), read-only memory (ROM), hard disks, solid state disks, or other nonvolatile storage media. Memory 1310 may also be provided in whole or in part by external storage in communication with the processor 1308.

Example methods herein may be performed by the processor 1308 or other processor in the server 1302 and/or processors in client devices 1304a, 1304b, 1304c, 1304d. It will be appreciated, as explained herein, that the processor 1308 can include either a single processor or multiple processors operating in series or in parallel, and that the memory 1310 can include one or more memories, including combinations of memory types and/or locations. Server 1300 may also include, but are not limited to, dedicated servers, cloud-based servers, or a combination (e.g., shared). Storage, for instance, for storing training data, trained models, etc., can be provided by local storage, external storage such as connected remote storage 1312 (shown in connection with the server 1302, but can likewise be connected to client devices), or any combination.

Client devices 1304a, 1304b, 1304c, 1304d may be any processor-based device, terminal, etc., and/or may be embodied in a client application executable by a processor-based device, etc. Client devices may be disposed within the server 1302 and/or external to the server (local or remote, or any combination) and in communication with the server. Example client devices 1304 include, but are not limited to, autonomous computers 1304a, mobile communication devices (e.g., smartphones, tablet computers, etc.) 1304b, robots 1304c, autonomous vehicles 1304d, wearable devices, computer vision devices, cameras, virtual reality, augmented reality, or mixed reality devices (not shown), or others. Client devices 1304 may be configured for sending data to and/or receiving data from the server 1302, and may include, but need not include, one or more output devices, such as but not limited to displays, printers, controllers, etc. for displaying, providing for display on a display, controlling a downstream operation, or printing results of certain methods that are provided for display by the server. Client devices may include combinations of client devices.

In an example NCO (Neural Combinatorial Optimization) method, the server 1302 or client devices 1304 having a trained or trainable policy model architecture, e.g., a trained or trainable policy network, may receive an input COP instance from any suitable source, e.g., by local or remote input from a suitable interface, or from another of the server or client devices connected locally or over the network 1306. The input COP may involve, for instance, more of routing, scheduling, and bin packing. Training modules may be provided in any of the server 1302 or client devices 1304 or a combination for performing training operations for neural policy models implemented any of the server or client devices. Trained specialized models for solving NCO tasks, or NCO models to be trained for specialized tasks can be likewise stored in the server (e.g., memory 1310), client devices 1304, external storage 1312, or combination. In some example embodiments provided herein, training and/or inference may be performed offline or online (e.g., at run time), in any combination. Results, such as but not limited to determined (e.g., generated) COP solutions (complete, partial, next determined action, batch, etc.) and/or trained policy models, can be output (e.g., displayed, transmitted, provided for display, printed, etc.), used for one or more downstream actions, and/or stored for retrieving and providing on request. Generated actions may be provided, communicated, or stored individually, in partial or complete batches (e.g., lists, schedules, etc.), or any combination.

An example NCO task involves routing autonomous devices or vehicles (e.g., robots, cars, drones, etc.) for performing one or more tasks (e.g., a delivery task, etc.) within a delimited space (e.g., building, warehouse, etc.). Another example NCO task involves allocating resources (e.g., the use of a workspace, a tool, an autonomous device or vehicle, bin packing, etc.) for performing one or more tasks. Yet another example NCO task involves both routing autonomous vehicles and allocating resources.

As a nonlimiting example, the COP may be a TSP or a CVRP, generated actions may include a selected next feasible node, and an autonomous device may be controlled (directly or indirectly) to move to the selected next feasible node. As another nonlimiting example, the COP may be a KP, the generated actions may include a selected feasible item; and an autonomous device may be controlled (directly or indirectly) to procure the selected feasible item. As yet another nonlimiting example, the COP may be a MATAP, the generated actions may include a an assigned task and assigned agent; and an agent may be controlled (directly or indirectly) to perform the assigned task, where the assigned agent includes or is an autonomous device.

Generally, embodiments can be implemented as computer program products with a program code or computer-executable instructions, the program code or computer-executable instructions being operative for performing one of the methods when the computer program product runs on a computer. The program code or the computer-executable instructions may, for example, be stored on a computer-readable storage medium.

In an embodiment, a storage medium (or a data carrier, or a computer-readable medium) comprises, stored thereon, the computer program or the computer-executable instructions for performing one of the methods described herein when it is performed by a processor.

Embodiments described herein may be implemented in hardware or in software. The implementation can be performed using a non-transitory storage medium such as a computer-readable storage medium, for example a floppy disc, a DVD, a Blu-Ray, a CD, a ROM, a PROM, and EPROM, an EEPROM or a FLASH memory. Such computer-readable media can be any available media that can be accessed by a general-purpose or special-purpose computer system.

### General

Embodiments herein provide, among other things, a method for training a neural network to solve a combinatorial optimization problem (COP), the method comprising: receiving a solution space for the COP that is a set of partial solutions for the COP, each partial solution including a sequence of one or more steps, wherein the COP has a set of COP instances, each of the set of COP instances including an objective and a finite, non-empty set of feasible solutions; modeling the COP as a Markov Decision Process (MDP) over the solution space using a neural policy model for generating a sequence of actions over a plurality of time steps from an initial time step to a final time step according to a policy to provide an outcome, the neural policy model including a set of trainable policy parameters, wherein each generated action is either a step taken from a finite set of steps or a neutral action; and training the neural policy model, wherein said training comprises, for each of one or more initial COP instances: at each of the plurality of time steps: a) inputting to the neural policy model an input COP instance from the set of COP instances, the input COP instance being the initial COP instance at the initial time step or an updated COP instance from a previous time step at a remainder of the time steps, wherein each instance in the set of COP instances is an instance of the COP; b) receiving a determined action based on the policy from the neural policy model; c) if the determined action is the neutral action, maintaining the input COP instance; d) if the determined action is a step, updating the input COP instance based on the step to provide the updated COP instance for a next time step, wherein said updating the input COP instance updates the set of feasible solutions and the objective, wherein the updated COP instance defines a tail subproblem of the input COP instance; and e) if the determined action is a step, repeating steps a)-e) for the next time step; and updating the policy parameters to optimize the neural policy model. In addition to any of the above features in this paragraph, the neural policy model may be trained to solve a plurality of COP instances including one or more of autonomous vehicle routing and resource allocation. In addition to any of the above features in this paragraph, the method may further comprise: inputting a new COP instance to the trained neural policy model, wherein the trained neural policy model outputs one or more generated actions. In addition to any of the above features in this paragraph, the one or more generated actions may provide a complete solution to the new COP instance. In addition to any of the above features in this paragraph, the one or more generated actions may provide a partial complete solution to the new COP instance. In addition to any of the above features in this paragraph, the one or more generated actions may be a next determined action. In addition to any of the above features in this paragraph, the one or more generated actions may comprise one or more actions for controlling an autonomous device. In addition to any of the above features in this paragraph, the autonomous device may comprise a robot. In addition to any of the above features in this paragraph, the autonomous device may comprise an autonomous vehicle. In addition to any of the above features in this paragraph, during said training the neural policy model, the one or more initial COP instances may comprise a plurality of initial COP instances from a distribution of COP instances. In addition to any of the above features in this paragraph, the input new COP instance to the trained neural policy model may be from a second distribution that is different from the first distribution. In addition to any of the above features in this paragraph, the input new COP instance may be larger than the COP instances in the first distribution. In addition to any of the above features in this paragraph, the objective may have a domain contained in the set of all partial solutions and well-defined for any of the set of possible partial solutions in the received solution space, and the set of all partial solutions may be the solution space. In addition to any of the above features in this paragraph, at each of the plurality of time steps, the MDP may have a state space that is the set of COP instances. In addition to any of the above features in this paragraph, the plurality of time steps may comprise t=1 . . . n time steps, the initial time step may be t=1, the previous time step for step t may be t=t−1, the next time step may be t=t+1, and the final time step may be t=n in which the neural policy model may determine the neutral action. In addition to any of the above features in this paragraph, the input COP instance may provide an initial state to the MDP, and at each of the plurality of time steps the updated COP instance may provide an updated state to the MDP. In addition to any of the above features in this paragraph, the solution space for the COP may be a set of all possible partial solutions for the COP; and the COP may be modeled as a Markov Decision Process (MDP) over the entire solution space. In addition to any of the above features in this paragraph, for each of the plurality of time steps, the determined action may update the sequence of generated actions; the updated sequence of actions may build a partial solution to the COP defined by the initial COP instance; and updating the COP instance may provide a mapping from the built partial solution to the updated COP instance. In addition to any of the above features in this paragraph, the built partial solution may provide a direct state of a direct MDP corresponding to the initial COP instance; the updated COP instance may provide an updated state corresponding to a reduced MDP; and the updated state may be a reduced state relative to the direct state. In addition to any of the above features in this paragraph, the mapping may be a bisimulation between the direct MDP and the reduced MDP. In addition to any of the above features in this paragraph, the reduced MDP may be a quotient of the direct MDP. In addition to any of the above features in this paragraph, the direct MDP may be a tail-recursive MDP. In addition to any of the above features in this paragraph, the direct MDP may be defined at a level of an individual COP instance, and the reduced MDP may be defined at a level of the entire solution space of COP instances. In addition to any of the above features in this paragraph, the neural policy model may comprise one or more of: a self-attention layer; a feedforward layer; a light attention model; or an attention-based model including an encoder. In addition to any of the above features in this paragraph, at each of the plurality of time steps the attention-based model may provide a latent representation of the input COP instance. In addition to any of the above features in this paragraph, training the policy may use one of reinforcement learning (RL) and imitation learning. In addition to any of the above features in this paragraph, the objective may be calculated from the feasible solutions using a real-valued function, and optimizing the policy may minimize the objective for the COP. In addition to any of the above features in this paragraph, at each of the plurality of time steps updating the input COP instance may comprise determining a reward based on the determined action and the objective in the input COP instance. In addition to any of the above features in this paragraph, at each of the plurality of the steps, the updated COP instance and the input COP instance may be representable in a same parametric space. In addition to any of the above features in this paragraph, during training the neural policy model, the one or more initial COP instances may comprise a plurality of initial COP instances from a distribution of COP instances. In addition to any of the above features in this paragraph, each of the plurality of initial COP instances may be associated with an expert trajectory; and updating the policy parameters may comprise determining a loss based on the expert trajectory. In addition to any of the above features in this paragraph, one or more of the plurality of initial COP instances in the distribution may be generated from others of the plurality of initial COP instances in the distribution. In addition to any of the above features in this paragraph, the method may further comprise: inputting a new COP instance to the trained neural policy model, wherein the trained neural policy model may output one or more generated actions. In addition to any of the above features in this paragraph, the one or more generated actions may provide a complete solution to the new COP instance. In addition to any of the above features in this paragraph, the one or more generated actions may provide a partial solution to the new COP instance. In addition to any of the above features in this paragraph, the one or more generated actions may be a next determined action. In addition to any of the above features in this paragraph, the one or more generated actions may comprise one or more actions for controlling an autonomous device. In addition to any of the above features in this paragraph, the autonomous device may comprise a robot. In addition to any of the above features in this paragraph, the autonomous device may comprise an autonomous vehicle. In addition to any of the above features in this paragraph, during training the neural policy model, the one or more initial COP instances may comprise a plurality of initial COP instances from a distribution of COP instances; and the input new COP instance to the trained neural policy model may be from a second distribution that is different from the first distribution. In addition to any of the above features in this paragraph, the input new COP instance may be larger than the COP instances in the first distribution. In addition to any of the above features in this paragraph, the COP may be a Capacitated Vehicle Routing Problem (CVRP); the COP instance may be defined by an initial capacity and by a set of nodes including an origin and a destination that are points in a Euclidean space, each of the set of nodes being associated with a demand; the solution space may be the set of finite sequences of nodes; the step taken from the finite set of steps may be a selected feasible node; in the initial COP instance, the initial capacity may be a full capacity, the origin and destination may be the same, and a goal of the CVRP may be to find a set of subtours for the vehicle having an origin and destination both at the origin such that all the nodes are visited, the sum of the demands per subtour does not exceed the capacity, and a total traveled distance by the vehicle is minimized; and at each of the plurality of time step, updating the COP instance may comprise updating the origin to be a last determined step by the neural policy model while the destination is the origin defined by the initial COP instance, and updating the initial capacity. In addition to any of the above features in this paragraph, at each of the plurality of time steps, the updated COP instance may comprise the destination, the updated origin, the remaining nodes in the set of nodes, and the updated capacity; the destination, the updated origin, the remaining nodes, demand associated with each of the nodes, and the updated capacity may be input to an embedding layer connected to the neural policy model; and the neural policy model may further receive an indication of the destination and the updated origin. In addition to any of the above features in this paragraph, the method may further comprise: inputting a new COP instance to the trained neural policy model, wherein the trained neural policy model outputs one or more generated actions, and the one or more generated actions comprise a selected next feasible node; and controlling an autonomous device to move to the selected next feasible node. In addition to any of the above features in this paragraph, the COP may be a Knapsack Problem (KP); the COP instance may be defined by a set of items in a feature space with weight and value features and a capacity; the partial solution may be defined by a set of finite subsets of items; the step taken from the finite set of steps may be a selected feasible item; the initial COP instance may be defined by a set of items in a feature space with weight and value features and an initial capacity, a goal of the KP may be to select a subset of the items such that a combined weight of the selected subset of the items does not exceed the capacity while a cumulated value of the selected subset of the items is maximized; and for each of the plurality of time steps, updating the COP instance may comprise reducing the set of items and reducing the capacity. In addition to any of the above features in this paragraph, at each of the plurality of time steps, the updated COP instance may comprise the destination, the updated origin, the remaining nodes in the set of nodes, and the updated capacity; the destination, the updated origin, the remaining nodes, demand associated with each of the nodes, and the updated capacity may be input to an embedding layer connected to the neural policy model; and the neural policy model may further receive an indication of the destination and the updated origin. In addition to any of the above features in this paragraph, the method may further comprise: inputting a new COP instance to the trained neural policy model, wherein the trained neural policy model may output one or more generated actions, wherein the one or more generated actions may comprise a selected next feasible node; and the method may further comprise controlling an autonomous device to move to the selected next feasible node. In addition to any of the above features in this paragraph, the COP may be a Knapsack Problem (KP); the COP instance may be defined by a set of items in a feature space with weight and value features and a capacity; the partial solution may be defined by a set of finite subsets of items; the step taken from the finite set of steps may be a selected feasible item; the initial COP instance may be defined by a set of items in a feature space with weight and value features and an initial capacity, a goal of the KP may be to select a subset of the items such that a combined weight of the selected subset of the items does not exceed the capacity while a cumulated value of the selected subset of the items is maximized; and for each of the plurality of time steps, updating the COP instance may comprise reducing the set of items and reducing the capacity. In addition to any of the above features in this paragraph, at each of the plurality of time steps, the updated COP instance may comprise the remaining set of items and the updated capacity; the remaining set of items and the updated capacity may be input to an embedding layer connected to the neural policy model; and training the neural policy model may use a multi-class cross-entropy loss. In addition to any of the above features in this paragraph, the method may further comprise: inputting a new COP instance to the trained neural policy model, wherein the trained neural policy model may output one or more generated actions, the one or more generated actions may comprise a selected feasible item; and the method may further comprise controlling an autonomous device to procure the selected feasible item. In addition to any of the above features in this paragraph, the COP may be a multi-agent task assignment problem (MATAP); the solution space may be a set of plans, each plan comprising an assignment of a finite sequence of tasks to each of a set of agents, satisfying an order consistency condition, the agents each may be associated with an agent duration to reach a task and to switch between tasks, the tasks may be associated with a processing duration; the step may be a plan in which one task is visited by one or more agents; the feasible set may be the set of plans that satisfy a feasibility constraint; and a COP instance may be defined by the set of tasks, the set of agents, the agent duration, the processing duration, date parameters, and the feasibility constraint. In addition to any of the above features in this paragraph, the MATAP may have a reduced feasibility constraint. In addition to any of the above features in this paragraph, at each of the plurality of steps, training the neural policy model may use a k-nearest neighbor heuristic to reduce a search space. In addition to any of the above features in this paragraph, the method may further comprise: inputting a new COP instance to the trained neural policy model, wherein the trained neural policy model may output one or more generated actions, the one or more generated actions may comprise an assigned task and assigned agent; and the method may further comprise causing the assigned agent to perform the assigned task; wherein the assigned agent may comprise an autonomous device.

Additional embodiments provide, among other things, a method for training a neural network to solve a neural combinatorial optimization problem (COP), the method comprising: providing a processor-based policy neural network comprising: an input embedding layer for embedding an input COP instance that satisfies a recursive property, the input COP instance defining a finite, non-empty set of feasible solutions and an objective calculated from each of the feasible solutions; a neural policy model having trainable policy parameters, the neural policy model being configured to encode the embedded COP instance and generate either a next action or a neutral action from the encoded COP instance as a construction step in a Markov Decision Process (MDP) having t=1 . . . n steps, wherein the neural policy model generates a neutral action at step n; and an instance updating block configured to update the input COP instance based on the generated next action and output the updated COP instance to the input embedding layer for a subsequent step as a new input COP instance, wherein updating the input instance updates both the set of feasible solutions and the objective, wherein each instance in the set of COP instances is an instance of the COP, wherein at each of t=1 . . . n steps the updated COP instance is reduced with respect to the input COP instance while preserving a structure of the COP by corresponding to a remaining subproblem of the COP when a partial solution is fixed, and training the neural policy model to optimize the policy parameters using a processor. In addition to any of the above features in this paragraph, the COP may be one of a Traveling Salesman Problem (TSP), a Knapsack Problem (KP), a Capacitated Vehicle Routing Problem (CVRP) and a Multi-Agent Task Assignment Problem (MATAP).

Additional embodiments provide, among other things, a method for training a neural network to solve a combinatorial optimization problem (COP), the method comprising: receiving a solution space [symbol] for the COP that is a set of all possible partial solutions x for the COP, each partial solution including a sequence of one or more steps z, wherein the COP has a set of COP instances, each of the set of COP instances including an objective ƒ and a finite, non-empty set X of feasible solutions, wherein the objective ƒ has a domain containing X and is well-defined for any of the set of possible partial solutions in the received solution space, and wherein X is a subset of the solution space; providing a neural policy model for modeling the COP as a Markov Decision Process (MDP) over the solution space [symbol] for generating a sequence of actions over t=1 . . . n time steps according to a policy π to provide an outcome, the policy including a set of trainable policy parameters, wherein the MDP has a state space that is the set of COP instances, an action space that is either a step z taken from a finite set of steps or a neutral action, and a deterministic transition between states; and training the neural policy model, wherein said training comprises: at each time step t=1 . . . n, where the neural policy model determines the neutral action at time step n: a) inputting to the neural policy model an input COP instance from the set of COP instances, the input COP instance being an initial COP instance at time step t=1 or an updated COP instance from a previous time step t=t−1 at time steps t=2 . . . n, wherein the input COP instance provides a state to the MDP, wherein each instance in the set of COP instances is an instance of the COP; b) receiving a determined action based on the policy π from the neural policy model; c) if the determined action is the neutral action, maintaining the input COP instance; and d) if the determined action is a step z, updating the input COP instance based on the step z to provide the updated COP instance for a next time step t=t+1, wherein said updating the input COP instance updates the set of feasible solutions and the objective, wherein the updated COP instance defines a tail subproblem of the input COP instance; and e) for time steps t=1 . . . n−1, repeating steps a)-d); and updating the policy parameters to optimize the policy. In addition to any of the above features in this paragraph, the COP may be one of a Traveling Salesman Problem (TSP), a Knapsack Problem (KP), a Capacitated Vehicle Routing Problem (CVRP) and a Multi-Agent Task Assignment Problem (MATAP).

The foregoing description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification, and the following claims. All publications, patents, and patent applications referred to herein are hereby incorporated by reference in their entirety, without an admission that any of such publications, patents, or patent applications necessarily constitute prior art.

It should be understood that one or more steps within a method may be executed in different order (or concurrently) without altering the principles of the present disclosure. Further, although each of the embodiments is described above as having certain features, any one or more of those features described with respect to any embodiment of the disclosure may be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between features (e.g., between modules, circuit elements, semiconductor layers, etc.) may be described using various terms, such as “connected,” “engaged,” “coupled,” “adjacent,” “next to,” “on top of,” “above,” “below,” “disposed”, and similar terms. Unless explicitly described as being “direct,” when a relationship between first and second features is described in the disclosure herein, the relationship can be a direct relationship where no other intervening features are present between the first and second features, or can be an indirect relationship where one or more intervening features are present, either spatially or functionally, between the first and second features, where practicable. As used herein, the phrase “at least one of” A, B, and C or the phrase “at least one of” A, B, or C, should be construed to mean a logical (A OR B OR C), using a non-exclusive logical OR, and should not be construed to mean “at least one of A, at least one of B, and at least one of C.”

In the figures, the direction of an arrow, as indicated by an arrowhead, generally demonstrates an example flow of information, such as data or instructions, that is of interest to the illustration. A unidirectional arrow between features does not imply that no other information may be transmitted between features in the opposite direction.

Each module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module. Each module may be implemented using code. The term code, as used above, may include software, firmware, and/or microcode, and may refer to programs, routines, functions, classes, data structures, and/or objects.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The systems and methods described in this application may be partially or fully implemented by a special purpose computer created by configuring a general purpose computer to execute one or more particular functions embodied in computer programs. The functional blocks, flowchart components, and other elements described above serve as software specifications, which may be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

It will be appreciated that variations of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above and the following claims.

1. A method for training a neural network to solve a combinatorial optimization problem (COP), the method comprising:
receiving a solution space for the COP that is a set of partial solutions for the COP, each partial solution including a sequence of one or more steps,
wherein the COP has an initial COP instance in a set of COP instances, each of the set of COP instances including an objective and a finite, non-empty set of feasible solutions;
modeling the COP as a Markov Decision Process (MDP) over the solution space using a neural policy model for generating a sequence of actions over a plurality of time steps from an initial time step to a final time step according to a policy to provide an outcome, the neural policy model including a set of trainable policy parameters, wherein each generated action is either a step taken from a finite set of steps or a neutral action;
and
training the neural policy model, wherein said training comprises, for each of one or more initial COP instances:
at each of the plurality of time steps:
a) inputting to the neural policy model an input COP instance from the set of COP instances, the input COP instance being the initial COP instance at the initial time step or an updated COP instance from a previous time step at a remainder of the time steps, wherein each instance in the set of COP instances is an instance of the COP;
b) receiving a determined action based on the policy π from the neural policy model;
c) if the determined action is the neutral action, maintaining the input COP instance;
d) if the determined action is a step, updating the input COP instance based on the step to provide the updated COP instance for a next time step, wherein said updating the input COP instance updates the set of feasible solutions and the objective, wherein the updated COP instance defines a tail subproblem of the input COP instance; and
e) if the determined action is a step, repeating steps a)-e) for the next time step;
and
updating the policy parameters to optimize the neural policy model.

2. The method of claim 1, wherein the neural policy model is trained to solve a plurality of COP instances including one or more of autonomous vehicle routing and resource allocation.

3. The method of claim 1, further comprising:
inputting a new COP instance to the trained neural policy model, wherein the trained neural policy model outputs one or more generated actions.

4. The method of claim 3, wherein the one or more generated actions provide one of a complete solution to the new COP instance, and a partial solution to the new COP instance.

5. The method of claim 3, wherein the one or more generated actions is a next determined action.

6. The method of claim 3, wherein the one or more generated actions comprise one or more actions for controlling an autonomous device.

7. The method of claim 5, wherein the autonomous device comprises one of a robot and an autonomous vehicle.

8. The method of claim 3, wherein during said training the neural policy model, the one or more initial COP instances comprises a plurality of initial COP instances from a distribution of COP instances; and
wherein the input new COP instance to the trained neural policy model is from a second distribution that is different from the first distribution.

9. The method of claim 8, wherein the input new COP instance is larger than the COP instances in the first distribution.

10. The method of claim 1, wherein, the objective has a domain contained in the set of all partial solutions and is well-defined for any of the set of possible partial solutions in the received solution space, and wherein the set of all partial solutions is the solution space.

11. The method of claim 1, wherein, at each of the plurality of time steps, the MDP has a state space that is the set of COP instances.

12. The method of claim 1, wherein the plurality of time steps comprises t=1 . . . n time steps, the initial time step is t=1, the previous time step for step t=t−1, the next time step is t=t+1, and the final time step is t=n, in which the neural policy model determines the neutral action.

13. The method of claim 1, wherein the input COP instance provides an initial state to the MDP, and wherein at each of the plurality of time steps the updated COP instance provides an updated state to the MDP.

14. The method of claim 1, wherein the solution space for the COP is a set of all possible partial solutions for the COP; and
wherein the COP is modeled as a Markov Decision Process (MDP) over the entire solution space.

15. The method of claim 1,
wherein for each of the plurality of time steps, the determined action updates the sequence of generated actions;
wherein the updated sequence of actions builds a partial solution to the COP defined by the initial COP instance; and
wherein said updating the COP instance provides a mapping from the built partial solution to the updated COP instance.

16. The method of claim 15,
wherein the built partial solution provides a direct state of a direct MDP corresponding to the initial COP instance;
wherein the updated COP instance provides an updated state corresponding to a reduced MDP; and
wherein the updated state is a reduced state relative to the direct state.

17. The method of claim 16, wherein the mapping is a bisimulation between the direct MDP and the reduced MDP;
wherein the reduced MDP is a quotient of the direct MDP; and
wherein the direct MDP is a tail-recursive MDP.

18. The method of claim 17, wherein the direct MDP is defined at a level of an individual COP instance, and the reduced MDP is defined at a level of the entire solution space of COP instances.

19. The method of claim 1, wherein the neural policy model comprises one of:
a self-attention layer and a feedforward layer;
a light attention model; and
an attention-based model including an encoder;
wherein at each of the plurality of time steps the attention-based model provides a latent representation of the input COP instance.

20. The method of claim 1, wherein said training the policy uses one of reinforcement learning (RL) and imitation learning.

21. The method of claim 1, wherein the objective is calculated from the feasible solutions using a real-valued function, and wherein said optimizing the policy minimizes the objective for the COP.

22. The method of claim 1, wherein, at each of the plurality of time steps said updating the input COP instance comprises determining a reward based on the determined action and the objective in the input COP instance.

23. The method of claim 1, wherein at each of the plurality of the steps, the updated COP instance and the input COP instance are representable in a same parametric space.

24. The method of claim 1, wherein during said training the neural policy model, the one or more initial COP instances comprises a plurality of initial COP instances from a distribution of COP instances.

25. The method of claim 24, wherein each of the plurality of initial COP instances is associated with an expert trajectory; and
wherein said updating the policy parameters comprises determining a loss based on the expert trajectory.

26. The method of claim 25, wherein one or more of the plurality of initial COP instances in the distribution are generated from others of the plurality of initial COP instances in the distribution.

27. The method of claim 1, wherein:
the COP is a Traveling Salesman Problem (TSP);
the COP instance is defined by a set of nodes including an origin and a destination that are points in a Euclidean space;
the solution space is defined by the set of finite sequences of nodes;
the step taken from the finite set of steps is a selected feasible node;
wherein, in the initial COP instance the origin and destination are the same, and a goal of the TSP is to find a shortest path that starts at the origin, has a destination at the origin, and visits each other node exactly once; and
at each of the plurality of time steps, updating the COP instance updates the origin to be the selected node, while the destination is the origin defined by the initial COP instance.

28. The method of claim 27, wherein at each of the plurality of time steps, the updated COP instance comprises the destination, the updated origin, and the remaining nodes in the set of nodes;
wherein the destination, the updated origin, and the remaining nodes are input to an embedding layer connected to the neural policy model;
wherein the neural policy model further receives an indication of the destination and the updated origin.

29. The method of claim 27, further comprising:
inputting a new COP instance to the trained neural policy model, wherein the trained neural policy model outputs one or more generated actions, wherein the one or more generated actions comprise a selected next feasible node; and
controlling an autonomous device to move to the selected next feasible node.

30. The method of claim 1, wherein:
the COP is a Capacitated Vehicle Routing Problem (CVRP);
the COP instance is defined by an initial capacity and by a set of nodes including an origin and a destination that are points in a Euclidean space, each of the set of nodes being associated with a demand;
the solution space is the set of finite sequences of nodes;
the step taken from the finite set of steps is a selected feasible node;
in the initial COP instance, the initial capacity is a full capacity, the origin and destination are the same, and a goal of the CVRP is to find a set of subtours for the vehicle having an origin and destination both at the origin such that all the nodes are visited, the sum of the demands per subtour does not exceed the capacity, and a total traveled distance by the vehicle is minimized; and
at each of the plurality of time step, updating the COP instance comprises updating the origin to be a last determined step by the neural policy model while the destination is the origin defined by the initial COP instance, and updating the initial capacity.

31. The method of claim 30, wherein at each of the plurality of time steps, the updated COP instance comprises the destination, the updated origin, the remaining nodes in the set of nodes, and the updated capacity;
wherein the destination, the updated origin, the remaining nodes, demand associated with each of the nodes, and the updated capacity are input to an embedding layer connected to the neural policy model;
wherein the neural policy model further receives an indication of the destination and the updated origin.

32. The method of claim 30, further comprising:
inputting a new COP instance to the trained neural policy model, wherein the trained neural policy model outputs one or more generated actions, wherein the one or more generated actions comprise a selected next feasible node; and
controlling an autonomous device to move to the selected next feasible node.

33. The method of claim 1, wherein:
the COP is a Knapsack Problem (KP);
the COP instance is defined by a set of items in a feature space with weight and value features and a capacity;
the partial solution is defined by a set of finite subsets of items;
the step taken from the finite set of steps is a selected feasible item;
the initial COP instance is defined by a set of items in a feature space with weight and value features and an initial capacity, a goal of the KP is to select a subset of the items such that a combined weight of the selected subset of the items does not exceed the capacity while a cumulated value of the selected subset of the items is maximized; and
for each of the plurality of time steps, updating the COP instance comprises reducing the set of items and reducing the capacity.

34. The method of claim 33, wherein, at each of the plurality of time steps, the updated COP instance comprises the remaining set of items and the updated capacity;
wherein the remaining set of items and the updated capacity are input to an embedding layer connected to the neural policy model; and
wherein said training the neural policy model uses a multi-class cross-entropy loss.

35. The method of claim 33, further comprising:
inputting a new COP instance to the trained neural policy model, wherein the trained neural policy model outputs one or more generated actions, wherein the one or more generated actions comprise a selected feasible item; and
controlling an autonomous device to procure the selected feasible item.

36. The method of claim 1, wherein:
the COP is a multi-agent task assignment problem (MATAP);
the solution space is a set of plans, each plan comprising an assignment of a finite sequence of tasks to each of a set of agents, satisfying an order consistency condition, the agents each being associated with an agent duration to reach a task and to switch between tasks, the tasks being associated with a processing duration;
the step is a plan in which one task is visited by one or more agents;
the feasible set is the set of plans that satisfy a feasibility constraint; and
a COP instance is defined by the set of tasks, the set of agents, the agent duration, the processing duration, date parameters, and the feasibility constraint.

37. The method of claim 36,
wherein the MATAP has a reduced feasibility constraint.

38. The method of claim 36, wherein, at each of the plurality of steps, said training the neural policy model uses a k-nearest neighbor heuristic to reduce a search space.

39. The method of claim 36, further comprising:
inputting a new COP instance to the trained neural policy model, wherein the trained neural policy model outputs one or more generated actions, wherein the one or more generated actions comprise an assigned task and assigned agent; and
causing the assigned agent to perform the assigned task;
wherein the assigned agent comprises an autonomous device.

40. A method for training a neural network to solve a neural combinatorial optimization problem (COP), the method comprising:
providing a processor-based policy neural network comprising:
an input embedding layer for embedding an input COP instance that satisfies a recursive property, the input COP instance defining a finite, non-empty set of feasible solutions and an objective calculated from each of the feasible solutions;
a neural policy model having trainable policy parameters, the neural policy model being configured to encode the embedded COP instance and generate either a next action or a neutral action from the encoded COP instance as a construction step in a Markov Decision Process (MDP) having t=1 . . . n steps, wherein the neural policy model generates a neutral action at step n; and
an instance updating block configured to update the input COP instance based on the generated next action and output the updated COP instance to the input embedding layer for a subsequent step as a new input COP instance, wherein updating the input instance updates both the set of feasible solutions and the objective, wherein in the set of COP instances is an instance of the COP,
wherein at each of t=1 . . . n steps the updated COP instance is reduced with respect to the input COP instance while preserving a structure of the COP by corresponding to a remaining subproblem of the COP when a partial solution is fixed, and
training the neural policy model to optimize the policy parameters using a processor.

41. The method of claim 40, wherein the COP is one of a Traveling Salesman Problem (TSP), a Knapsack Problem (KP), a Capacitated Vehicle Routing Problem (CVRP) and a MATAP (Multi-Agent Task Assignment Problem).

42. A method for training a neural network to solve a combinatorial optimization problem (COP), the method comprising:
receiving a solution space [symbol] for the COP that is a set of all possible partial solutions x for the COP, each partial solution including a sequence of one or more steps z,
wherein the COP has a set of COP instances, each of the set of COP instances including an objective ƒ and a finite, non-empty set X of feasible solutions, wherein the objective ƒ has a domain containing X and is well-defined for any of the set of possible partial solutions in the received solution space, and wherein X is a subset of the solution space;
providing a neural policy model for modeling the COP as a Markov Decision Process (MDP) over the solution space [symbol] for generating a sequence of actions over t=1 . . . n time steps according to a policy π to provide an outcome, the policy including a set of trainable policy parameters, wherein the MDP has a state space that is the set of COP instances, an action space that is either a step z taken from a finite set of steps or a neutral action, and a deterministic transition between states;
and
training the neural policy model, wherein said training comprises:
at each time step t=1 . . . n, where the neural policy model determines the neutral action at time step n:
a) inputting to the neural policy model an input COP instance from the set of COP instances, the input COP instance being an initial COP instance at time step t=1 or an updated COP instance from a previous time step t=t−1 at time steps t=2 . . . n, wherein the input COP instance provides a state to the MDP, wherein each instance in the set of COP instances is an instance of the COP;
b) receiving a determined action based on the policy r from the neural policy model;
c) if the determined action is the neutral action, maintaining the input COP instance; and
d) if the determined action is a step z, updating the input COP instance based on the step z to provide the updated COP instance for a next time step t=t+1, wherein said updating the input COP instance updates the set of feasible solutions and the objective, wherein the updated COP instance defines a tail subproblem of the input COP instance; and
e) for time steps t=1 . . . n−1, repeating steps a)-d);
and
updating the policy parameters to optimize the policy.

43. The method of claim 42, wherein the COP is one of a Traveling Salesman Problem (TSP), a Knapsack Problem (KP), a Capacitated Vehicle Routing Problem (CVRP) and a MATAP (Multi Agent Task Assignment Problem).
